(19) United States
(12) Patent Application Publication
(10) Pub. No.: US 2026/0079276 A1
(43) Pub. Date: Mar. 19, 2026

(54) SEISMIC SURVEY DATA VISUALIZATION

(71) Applicant: SCHLUMBERGER TECHNOLOGY CORPORATION, Sugar Land, TX (US)

(72) Inventors: Bjarte DYSVIK, Stavanger (NO); Stewart Smith, Stavanger (NO)

(21) Appl. No.: 19/110,852

(22) PCT Filed: Sep. 13, 2023
(86) PCT No.: PCT/US2023/074032

§ 371 Date: Mar. 12, 2025

Related U.S. Application Data
(60) Provisional application No. 63/406,560, filed on Sep. 14, 2022.

(51) Int. Cl. G01V 1/34; G06T 15/00

(52) U.S. Cl. CPC G01V 1/345; G06T 15/005; G01V 2210/74

(57) ABSTRACT

A method can include generating a visual group of datasets; receiving a visualization mesh that intersects at least two of the datasets; executing a shader using graphics hardware to generate values for the visualization mesh, where the values depend on data within at least one of the at least two datasets; and rendering a visualization to a display using the values.

### RELATED APPLICATION

This application claims priority to and the benefit of a U.S. Provisional Application having Ser. No. 63/406,560, filed 14 Sep. 2022, which is incorporated herein by reference in its entirety.

### BACKGROUND

Reflection seismology finds use in geophysics, for example, to estimate properties of subsurface formations. As an example, reflection seismology may provide seismic data representing waves of elastic energy (e.g., as transmitted by P-waves and S-waves, in a frequency range of approximately 1 Hz to approximately 100 Hz). Seismic data may be processed and interpreted, for example, to understand better composition, fluid content, extent and geometry of subsurface rocks. Various techniques described herein pertain to processing and visualization of data such as, for example, seismic data.

### SUMMARY

A method can include generating a visual group of datasets; receiving a visualization mesh that intersects at least two of the datasets; executing a shader using graphics hardware to generate values for the visualization mesh, where the values depend on data within at least one of the at least two datasets; and rendering a visualization to a display using the values. A system can include a processor; memory operatively coupled to the processor; a network interface; and processor-executable instructions stored in the memory to instruct the system to: generate a visual group of datasets; receive a visualization mesh that intersects at least two of the datasets; execute a shader using graphics hardware to generate values for the visualization mesh, where the values depend on data within at least one of the at least two datasets; and render a visualization to a display using the values. One or more computer-readable storage media can include processor-executable instructions to instruct a computing system to: generate a visual group of datasets; receive a visualization mesh that intersects at least two of the datasets; execute a shader using graphics hardware to generate values for the visualization mesh, where the values depend on data within at least one of the at least two datasets; and render a visualization to a display using the values. Various other apparatuses, systems, methods, etc., are also disclosed.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

Features and advantages of the described implementations can be more readily understood by reference to the following description taken in conjunction with the accompanying drawings.

FIG. 1 illustrates an example of a geologic environment and an example of a technique;

FIG. 2 illustrates an example of a geologic environment and examples of equipment;

FIG. 3 illustrates an example of a geologic environment, examples of equipment and an example of a method;

FIG. 4 illustrates an example of a seismic volume and an example of a slice;

FIG. 5 illustrates an example of a method;

FIG. 6 illustrates an example of a method;

FIG. 7 illustrates an example of a convention for a grid;

FIG. 8 illustrates an example of seismic volumes and a visualization;

FIG. 9 illustrates an example of seismic volumes and a visualization mesh;

FIG. 10 illustrates an example of a graphic as to an example of a visual group;

FIG. 11 illustrates an example of a visualization for multiple datasets;

FIG. 12 illustrates an example of a framework;

FIG. 13 illustrates an example of a method;

FIG. 14 illustrates an example of a shader graph;

FIG. 15 illustrates an example of a framework;

FIG. 16 illustrates an example of a method; and

FIG. 17 illustrates example components of a system and a networked system.

### DETAILED DESCRIPTION

The following description includes the best mode presently contemplated for practicing the described implementations. This description is not to be taken in a limiting sense, but rather is made merely for the purpose of describing the general principles of the implementations. The scope of the described implementations should be ascertained with reference to the issued claims.

As mentioned, reflection seismology finds use in geophysics, for example, to estimate properties of subsurface formations. As an example, reflection seismology may provide seismic data representing waves of elastic energy (e.g., as transmitted by P-waves and S-waves, in a frequency range of approximately 1 Hz to approximately 100 Hz). Seismic data may be processed and interpreted, for example, to understand better composition, fluid content, extent and geometry of subsurface rocks. As such, seismic data includes information that can characterize a subsurface environment.

As an example, a seismic imaging system can be utilized to perform seismic surveys. For example, consider a land-based survey of a subsurface region where sensors can be positioned according to a survey footprint that may cover an area of square kilometers where one or more seismic energy sources are fired to emit energy that can travel through the subsurface region such that at least a portion of the emitted energy can be received at one or more of the sensors.

As an example, a land-based survey can include an array of sensors for performing a seismic survey where emission vehicles can emit seismic energy to be sensed by the array of sensors where data can be collected by a receiver vehicle as operatively coupled to the array of sensors. In such an example, sensors may be deployed by an individual as that individual walks along paths, which may be, for example, inline or crossline paths associated with a seismic survey. For example, the individual may carry a rod where hooks may allow for looping a cable and where the hooks may be slide off an end of the rod as the individual positions the individual sensors. Individual sensors may, depending on environment, include spikes that can be inserted into the ground (e.g., spikes may be of a length of the order of about 10 cm and be capable of conducting seismic energy to circuitry of the individual sensors). As an example, a sensor may be a UNIQ sensor (SLB, Houston, Texas) or another type of sensor. As an example, a sensor can include an accelerometer or accelerometers. As an example, a sensor may be a geophone. As an example, a sensor may include circuitry for 1C acceleration measurement. As an example, a sensor may be self-testing and/or self-calibrating. As an example, a sensor can include memory, for example, to perform data buffering and optionally retransmission. As an example, a sensor can include short circuit isolation circuitry, open circuit protection circuitry and earth-leakage detection and/or isolation circuitry. In various instances, sensors may be subject to environmental conditions such as lightening where circuitry may help to protect sensors from damage.

As an example, a sensor may include location circuitry (e.g., GPS, etc.). As an example, a sensor can include temperature measurement circuitry. As an example, a sensor can include humidity measurement circuitry. As an example, a sensor can include circuitry for automated re-routing of data and/or power (e.g., as to supply, connection, etc.). As an example, an array of sensors may be networked where network topology may be controllable, for example, to account for one or more damaged and/or otherwise inoperative sensors, etc.

As mentioned, sensors may be cabled to form a sensor string. As an example, consider a string of about 10 sensors where a lead-in length is about 7 meters, a mid-section length is about 14 meters and a weight is about 15 kg. As another example, consider a string of about 5 sensors where a lead-in length is about 15 meters and a mid-section length is about 30 meters and a weight is about 12 kg. Such examples may be utilized to understand dimensions of an array of sensors and, for example, how far a sensor is from one or more neighbors, to which it may be operatively coupled (e.g., via one or more conductors, conductive materials, etc.).

As an example, data may be stored in association with one or more types of metadata, which may include metadata as to specifics of a sensor or sensors, an arrangement of sensors, operational status of a sensor or sensors, etc. As an example, such metadata may be utilized for one or more purposes, which may include determination of a loading order for loading of stored data (e.g., for rendering, etc.). For example, a region that may have been subjected to a lightning strike may be indicated via metadata and/or analysis of acquired data where data for such a region may be ordered with respect to other data for purposes of loading (e.g., assessing lightning effected data prior to loading other data, not loading lightning effected data, etc.).

As to a power insertion unit (PIU), such a unit can be utilized for power and/or data routing. For example, such a unit may provide power for a few sensors to tens of sensors to hundreds of sensors (e.g., consider a PIU that can power 500 or more sensors).

As an example, an installation can include a fiber-optic exchanger unit (FOX). For example, such a unit may be a router that can communicate with a PIU. As an example, fiber optic cables may be included in an installation. For example, consider FOX and PIU fiber optic couplings.

As an example, an installation may include over a thousand sensors. As an example, an installation may include tens of thousands of sensors. As an example, an installation may include over one hundred thousand sensors.

As explained, survey acquisition equipment, whether land-based and/or marine-based, can include various types of equipment that are operatively coupled. As an example, noise may originate in one or more manners as to such equipment (e.g., consider lightning strike noise, shark bite noise, wake noise, earthquake noise, etc.).

As to a marine survey, it may involve towing one or more streamers behind a vessel where a streamer includes sensors where one or more seismic energy sources are fired to emit energy that can travel through water and a subsurface region such that at least a portion of the emitted energy can be received at one or more of the sensors. Some types of marine surveys may include equipment that is to be placed on the ocean bottom. For example, consider ocean-bottom cables (OBCs) and ocean-bottom nodes (OBNs). As explained with respect to the land-based equipment, various types of equipment can be utilized to power, acquire, process seismic data. As an example, marine-based equipment may include at least some features of such equipment.

As an example, in marine-based equipment can include sensors where each of the sensors may include at least one geophone and a hydrophone. A geophone may be a sensor configured for seismic acquisition, whether onshore and/or offshore, that can detect velocity produced by seismic waves and that can transform motion into electrical impulses. A geophone may be configured to detect motion in a single direction. A geophone may be configured to detect motion in a vertical direction. Three mutually orthogonal geophones may be used in combination to collect so-called 3C seismic data. A hydrophone may be a sensor configured for use in detecting seismic energy in the form of pressure changes under water during marine seismic acquisition. Hydrophones may be positioned along a string or strings to form a streamer or streamers that may be towed by a seismic vessel (or deployed in a bore).

A surface marine cable may be or include a buoyant assembly of electrical wires that connect sensors and that can relay seismic data to the recording seismic vessel. A multi-streamer vessel may tow more than one streamer cable to increase the amount of data acquired in one pass. A marine seismic vessel may be about 75 m long and travel about 5 knots per hour while towing arrays of air guns and streamers containing sensors, which may be located about a few meters below the surface of the water. A so-called tail buoy may assist crew in location an end of a streamer. An air gun may be activated periodically, such as about each 25 m (e.g., about at 10 second intervals) where the resulting sound wave travels into the Earth, which may be reflected back by one or more rock layers to sensors on a streamer, which may then be relayed as signals (e.g., data, information, etc.) to equipment on the tow vessel.

As to streamers, noise may occur due to vessel factors such as vessel speed, variation in speed, acceleration, waves impacting vessel performance, navigating around icebergs, making turns, etc. For example, where a vessel is to trace a path for a survey, the path can include turns that cause streamers to change in shape, which may cause bending, etc., changes in angles with respect to source originated seismic energy, etc. As vessel operations involves energy expenditure (e.g., liquid fuel, solar power, etc.), a survey may continue during turns of a survey path. As an example, a streamer may experience noise due to jetsam and/or flotsam, which may physically impact a streamer. As an example, a streamer may experience noise due to marine life such as, for example, noise due to a shark bite.

Streamer cables may be spooled onto drums for storage on a vessel, which subjects the streamer cables to various contact and bending forces, etc. (consider winding and unwinding operations).

Seismic data can be spatially two-dimensional or three-dimensional. Seismic data can be taken at different times, such as, for example, a pre-production time and a post-production time where differences can discern effects of production on a geologic region. In some examples, 3D seismic data can be 2D in space and 1D in time and 4D seismic data can be 3D in space and 1D in time; noting that in either instance, seismic signals are acquired with respect to time during a seismic survey (e.g., as may be sampled by seismic acquisition equipment to generate digital seismic data). Seismic data that are 2D spatially can be referred to as a slice (e.g., a 2D slice); while, seismic data that are 3D spatially can be referred to as a cube (e.g., volumetric seismic data).

As to seismic acquisition geometry of a seismic survey, a 2D grid can be considered to be dense where line spacing is less than about 400 m. As to 3D acquisition of seismic data, such an approach may be utilized to uncover (e.g., via interpretation) true structural dip (2D may give apparent dip), enhanced stratigraphic information, a map view of reservoir properties, enhanced areal mapping of fault patterns and connections and delineation of reservoir blocks, and enhanced lateral resolution (e.g., 2D may exhibit detrimental cross-line smearing or Fresnel zone issues).

A 3D seismic dataset can be referred to as a cube or volume of data; a 2D seismic data set can be referred to as a panel of data. To interpret 3D data, processing can be on the “interior” of the cube, which tends to be an intensive computation process because massive amounts of data are involved. For example, a 3D dataset can range in size from a few tens of megabytes to several gigabytes or more.

A 3D seismic data volume can include a vertical axis that is two-way traveltime (TWT) rather than depth and can include data values that are seismic amplitudes values. Such data may be defined at least in part with respect to a time axis where a trace may be a data vector of values with respect to time.

Acquired field data may be formatted according to one or more formats. For example, consider a well data format AAPG-B, log curve formats LAS or LIS-II, seismic trace data format SEGY, shotpoint locations data formats SEGP1 or UKOOA and wellsite data format WITS.

As to SEGY, which may be referred to as SEG-Y or SEG Y, it is a file format developed by the Society of Exploration Geophysicists (SEG) for storing geophysical data. It is an open standard, and is controlled by the SEG Technical Standards Committee, a non-profit organization. The format was originally developed in 1973 to store single-line seismic reflection digital data on magnetic tapes. The most recent revision of the SEG-Y format was published in 2017, named the rev 2.0 specification and includes certain legacies of the original format (referred as rev 0), such as an optional SEG-Y tape label, the main 3200-byte textual EBCDIC character encoded tape header and a 400-byte binary header.

A format referred to as ZGY (or zgy) is a file format that can be used for storing 3D seismic trace data. Data may be converted to ZGY from SEG-Y format. The ZGY format supports compression of data. ZGY uses bricking to store multiple resolutions of a dataset. As an example, a brick may include 64×64×64 samples, though brick sizes can vary. ZGY can be a compressed format of the SEG-Y data such that the ZGY format demands less storage space, where ZGY format data may be readily exchangeable.

The AAPG Computer Applications Committee has proposed the AAPG-B data exchange format for general purpose data transfers among computer systems, applications software, and companies. For log curves, the SLB LIS (log information standard) has become a de facto standard, and extensions to it have been proposed. Another log data format called LAS, for log ASCII standard, has been proposed by the Canadian Well Logging Society. The UKOOA format is from the United Kingdom Offshore Operators Association. WITS is a format for transferring wellsite data (wellsite information transfer standard) as proposed by the International Association of Drilling Contractors (IADC).

A computational system may include or may provide access to a relational database management system (RDBMS). As an example, a query language such as SQL (Structured Query Language) may be utilized.

As an example, a machine can acquire seismic data and can process the seismic data via circuitry of the machine, which can include one or more processors and memory accessible to at least one processor. Such a machine can include one or more interfaces that can be operatively coupled to one or more pieces of equipment, whether by wire or wirelessly (e.g., via wireless communication circuitry). As an example, such a machine may be a seismic imager that can generate an image based at least in part on seismic data. Such an image can be a model according to one or more equations and may be an image of structure of a subterranean environment and/or an image of noise, which may be due to one or more phenomena. As an example, a seismic image can be in one or more types of domains. For example, consider a spatial and temporal domain where one dimension is spatial and another dimension is temporal. Such a domain may be utilized for seismic traces that are amplitude values with respect to time as acquired by a receiver of seismic survey equipment. As an example, time may be transformed to depth or other spatial dimension. In such an example, a seismic image can be in a spatial domain with two spatial dimensions.

An image can be a multidimensional construct that is at least in part seismic data-based. For example, a digital camera of a smartphone can process data acquired by a CCD array utilizing a model such that the model and associated values may be rendered to a display of the smartphone.

In a CCD image sensor, pixels are represented by p-doped metal-oxide-semiconductors (MOS) capacitors. These capacitors are biased above the threshold for inversion when image acquisition begins, allowing the conversion of incoming photons into electron charges at the semiconductor-oxide interface; the CCD image sensor is then used to read out these charges. Instructions executable by a processor of a smartphone can receive the charges as sensor data. Where a CCD is configured to be sensitive to color, it may utilize a Bayer mask over the CCD array where, for example, each square of four pixels has one filtered red, one blue, and two green such that luminance information is collected at every pixel, but the color resolution is lower than the luminance resolution. A color model that can include features of an RGB colorspace model can be utilized by the smartphone to generate data that can be then rendered to a display. Ultimately, the rendering to the display is a model with particular values that depend on the acquired CCD image sensor data.

In seismic imaging, rather than photons, seismic energy is sensed. Further, the amount of data sensed tends to be orders of magnitude greater than that of a digital camera of a smartphone. Yet further, a region “sensed” (e.g., surveyed) is generally not visible to the eye. Various types of models can be utilized for seismic imaging such that, for example, rendering can occur to a display of information that is based at least in part on sensed data.

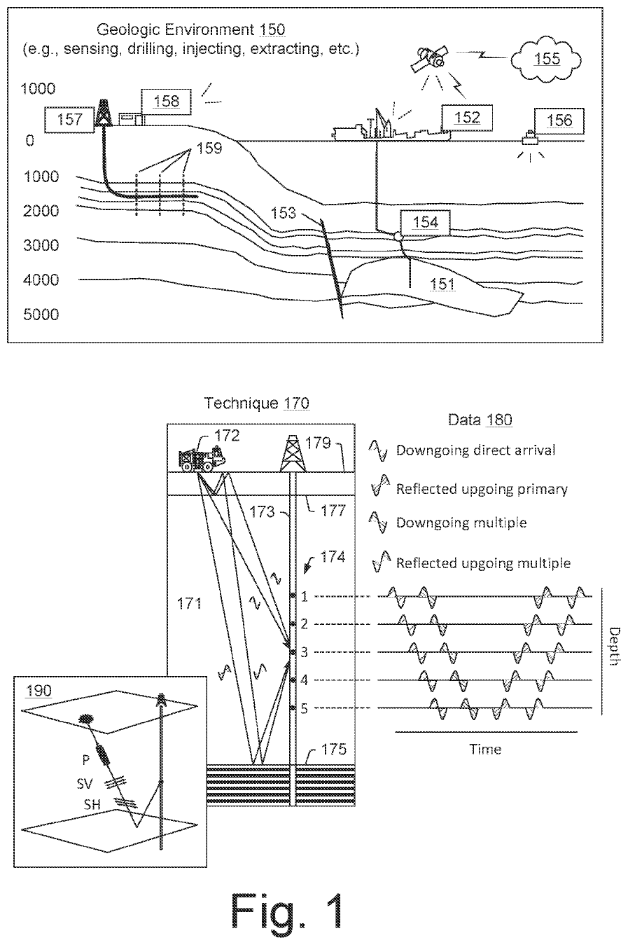

FIGS. 1, 2 and 3, present various examples of equipment and techniques associated with seismic data.

FIG. 1 shows an example of a geologic environment 150 (e.g., an environment that includes a sedimentary basin, a reservoir 151, one or more fractures 153, etc.) and an example of an acquisition technique 170 to acquire seismic data. As an example, a system may process data acquired by the technique 170, for example, to allow for direct or indirect management of sensing, drilling, injecting, extracting, etc., with respect to the geologic environment 150. In turn, further information about the geologic environment 150 may become available as feedback (e.g., optionally as input to the system).

As an example, a system may include features of a simulation framework such as the PETREL seismic to simulation software framework (SLB, Houston, Texas). The PETREL framework provides components that allow for optimization of exploration and development operations. The PETREL framework includes seismic to simulation software components that can output information for use in increasing reservoir performance, for example, by improving asset team productivity. Through use of such a framework, various professionals (e.g., geophysicists, geologists, and reservoir engineers) can develop collaborative workflows and integrate operations to streamline processes. Such a framework may be considered an application and may be considered a data-driven application (e.g., where data is input for purposes of simulating a geologic environment).

As an example, a framework may be implemented within or in a manner operatively coupled to the DELFI cognitive exploration and production (E&P) environment (SLB, Houston, Texas), which is a secure, cognitive, cloud-based collaborative environment that integrates data and workflows with digital technologies, such as artificial intelligence and machine learning. As an example, such an environment can provide for operations that involve one or more frameworks.

A reservoir can be a subsurface formation that can be characterized at least in part by its porosity and fluid permeability. As an example, a reservoir may be part of a basin such as a sedimentary basin. A basin can be a depression (e.g., caused by plate tectonic activity, subsidence, etc.) in which sediments accumulate. As an example, where hydrocarbon source rocks occur in combination with appropriate depth and duration of burial, a petroleum system may develop within a basin, which may form a reservoir that includes hydrocarbon fluids (e.g., oil, gas, etc.).

In oil and gas exploration, interpretation is a process that involves analysis of data to identify and locate various subsurface structures (e.g., horizons, faults, geobodies, etc.) in a geologic environment. Various types of structures (e.g., stratigraphic formations) may be indicative of hydrocarbon traps or flow channels, as may be associated with one or more reservoirs (e.g., fluid reservoirs). In the field of resource extraction, enhancements to interpretation can allow for construction of a more accurate model of a subsurface region, which, in turn, may improve characterization of the subsurface region for purposes of resource extraction. Characterization of one or more subsurface regions in a geologic environment can guide, for example, performance of one or more operations (e.g., field operations, etc.). As an example, a more accurate model of a subsurface region may make a drilling operation more accurate as to a borehole's trajectory where the borehole is to have a trajectory that penetrates a reservoir, etc., where fluid may be produced via the borehole (e.g., as a completed well, etc.). As an example, one or more workflows may be performed using one or more computational frameworks that include features for one or more of analysis, acquisition, model building, control, etc., for exploration, interpretation, drilling, fracturing, production, etc.

In the example of FIG. 1, the geologic environment 150 may include layers (e.g., stratification) that include a reservoir 151 and that may be intersected by a fault 153. As an example, a geologic environment may be or include an offshore geologic environment, a seabed geologic environment, an ocean bed geologic environment, etc.

As an example, the geologic environment 150 may be outfitted with one or more of a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a well site and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite in communication with the network 155 that may be configured for communications, noting that the satellite may additionally or alternatively include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop the reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

As an example, a system may be used to perform one or more workflows. A workflow may be a process that includes a number of worksteps. A workstep may operate on data, for example, to create new data, to update existing data, etc. As an example, a system may operate on one or more inputs and create one or more results, for example, based on one or more algorithms. As an example, a system may include a workflow editor for creation, editing, executing, etc. of a workflow. In such an example, the workflow editor may provide for selection of one or more pre-defined worksteps, one or more customized worksteps, etc. As an example, a workflow may be a workflow implementable in a framework, computational environment, etc., that operates on seismic data, seismic attribute(s), etc. As an example, a workflow may be a process implementable in the DELFI environment, etc. As an example, a workflow may include one or more worksteps that access a module such as a plug-in (e.g., external executable code, etc.).

As an example, a seismic data can be utilized in building an earth model, which may include a mesh that can be utilized to discretize equations for a simulator. In such an example, one or more types of simulations may be performed as to physical phenomena such as, for example, fluid flow, phase behavior, stress, strain, acoustic energy, etc. As an example, a simulator such as the ECLIPSE simulator (SLB, Houston, Texas) or the INTERSECT simulator (SLB, Houston, Texas) may be utilized for simulation of fluid flow in a geologic environment. Simulations may be more accurate where an earth model is more accurate. For example, as simulation can be based on partial differential equations that account for physical phenomena, a more accurate representation of an actual physical environment can help to improve simulation accuracy and simulator performance (e.g., ability for a simulator to iteratively converge to a solution).

As an example, a feedback loop may exist between model building and simulation where inaccuracies in simulation results (e.g., a solution) can be identified in association with a region of a geologic environment and where that region may be re-interpreted. For example, consider a workflow that includes determining a loading order for seismic data for interpretation, which may include re-interpretation, that is based at least in part on simulation results (e.g., a region where physical phenomena may be of interest, where inaccuracies exist, etc.). In such an example, expediting loading of a particular region or regions may facilitate re-interpretation and revised model building and, hence, re-simulation based at least in part on the revised model.

In FIG. 1, the technique 170 may be implemented with respect to a geologic environment 171. As shown, an energy source (e.g., a transmitter) 172 may emit energy where the energy travels as waves that interact with the geologic environment 171. As an example, the geologic environment 171 may include a bore 173 where one or more sensors (e.g., receivers) 174 may be positioned in the bore 173. As an example, energy emitted by the energy source 172 may interact with a layer (e.g., a structure, an interface, etc.) 175 in the geologic environment 171 such that a portion of the energy is reflected, which may then be sensed by one or more of the sensors 174. Such energy may be reflected as an upgoing primary wave (e.g., or “primary”). As an example, a portion of emitted energy may be reflected by more than one structure in the geologic environment and referred to as a multiple reflected wave (e.g., or “multiple”). For example, the geologic environment 171 is shown as including a layer 177 that resides below a surface layer 179. Given such an environment and arrangement of the source 172 and the one or more sensors 174, energy may be sensed as being associated with particular types of waves.

As shown in FIG. 1, acquired data 180 can include data associated with downgoing direct arrival waves, reflected upgoing primary waves, downgoing multiple reflected waves and reflected upgoing multiple reflected waves. The acquired data 180 is also shown along a time axis and a depth axis. As indicated, in a manner dependent at least in part on characteristics of media in the geologic environment 171, waves travel at velocities over distances such that relationships may exist between time and space. Thus, time information, as associated with sensed energy, may allow for understanding spatial relations of layers, interfaces, structures, etc. in a geologic environment.

FIG. 1 also shows various types of waves as including P, SV an SH waves. As an example, a P-wave may be an elastic body wave or sound wave in which particles oscillate in the direction the wave propagates. As an example, P-waves incident on an interface (e.g., at other than normal incidence, etc.) may produce reflected and transmitted S-waves (e.g., “converted” waves). As an example, an S-wave or shear wave may be an elastic body wave, for example, in which particles oscillate perpendicular to the direction in which the wave propagates. S-waves may be generated by a seismic energy source (e.g., other than an air gun). As an example, S-waves may be converted to P-waves. S-waves tend to travel more slowly than P-waves and do not travel through fluids that do not support shear. In general, recording of S-waves involves use of one or more receivers operatively coupled to earth (e.g., capable of receiving shear forces with respect to time). As an example, interpretation of S-waves may allow for determination of rock properties such as fracture density and orientation, Poisson's ratio and rock type, for example, by crossplotting P-wave and S-wave velocities, and/or by other techniques.

As an example of parameters that can characterize anisotropy of media (e.g., seismic anisotropy), consider the Thomsen parameters ε, δ and γ. The Thomsen parameter δ can describe offset effects (e.g., short offset). As to the Thomsen parameter ε, it can describe offset effects (e.g., a long offset) and can relate to a difference between vertical and horizontal compressional waves (e.g., P or P-wave or quasi compressional wave qP or qP-wave). As to the Thomsen parameter γ, it can describe a shear wave effect. For example, consider an effect as to a horizontal shear wave with horizontal polarization to a vertical shear wave.

As an example, seismic data may be acquired for a region in the form of traces. In the example of FIG. 1, the technique 170 may include the source 172 for emitting energy where portions of such energy (e.g., directly and/or reflected) may be received via the one or more sensors 174. As an example, energy received may be discretized by an analog-to-digital converter that operates at a sampling rate. For example, acquisition equipment may convert energy signals sensed by a sensor to digital samples at a rate of one sample per approximately 4 ms. Given a speed of sound in a medium or media, a sample rate may be converted to an approximate distance. For example, the speed of sound in rock may be of the order of around 5 km per second. Thus, a sample time spacing of approximately 4 ms would correspond to a sample “depth” spacing of about 10 meters (e.g., assuming a path length from source to boundary and boundary to sensor). As an example, a trace may be about 4 seconds in duration; thus, for a sampling rate of one sample at about 4 ms intervals, such a trace would include about 1000 samples where latter acquired samples correspond to deeper reflection boundaries. If the 4 second trace duration of the foregoing example is divided by two (e.g., to account for reflection), for a vertically aligned source and sensor, the deepest boundary depth may be estimated to be about 10 km (e.g., assuming a speed of sound of about 5 km per second). As an example, a seismic trace can be a vector with amplitude values where each entry in the vector represents a sample, for example, as sampled according to a sampling rate of a receiver. Such a vector can be amplitude with respect to time for a particular receiver, for a particular “shot” of a seismic source, etc.

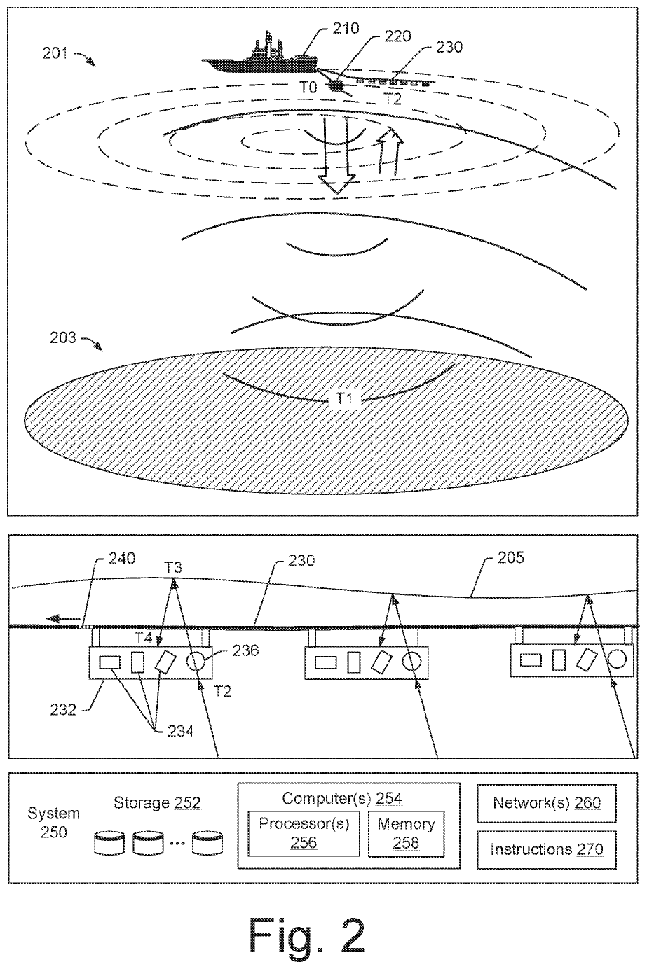

FIG. 2 shows an example of a geologic environment 201 that includes a seabed 203 and a sea surface 205. As shown, equipment 210 such as a ship may tow an energy source 220 and a string of sensors 230 at a depth below the sea surface 205 (e.g., one or more streamers, etc.). In such an example, the energy source 220 may emit energy at a time TO, a portion of that energy may be reflected from the seabed 203 at a time T1 and a portion of that reflected energy may be received at the string of sensors 230 at a time T2.

As mentioned with respect to the technique 170 of FIG. 1, a wave may be a primary or a multiple. As shown in an enlarged view of the geologic environment 201, the sea surface 205 may act to reflect waves such that sensors 232 of the string of sensors 230 may sense multiples as well as primaries. In particular, the sensors 232 may sense so-called sea surface multiples, which may be multiples from primaries or multiples of multiples (e.g., due to sub-seabed reflections, etc.).

As an example, each of the sensors 232 may sense energy of an upgoing wave at a time T2 where the upgoing wave reflects off the sea surface 205 at a time T3 and where the sensors may sense energy of a downgoing multiple reflected wave at a time T4 (see also the data 180 of FIG. 1 and data 240 of FIG. 2). In such an example, sensing of the downgoing multiple reflected wave may be considered noise that interferes with sensing of one or more upgoing waves. As an example, an approach that includes summing data acquired by a geophone and data acquired by a hydrophone may help to diminish noise associated with downgoing multiple reflected waves. Such an approach may be employed, for example, where sensors may be located proximate to a surface such as the sea surface 205 (e.g., arrival times T2 and T4 may be relatively close). As an example, the sea surface 205 or a water surface may be an interface between two media. For example, consider an air and water interface. As an example, due to differing media properties, sound waves may travel at about 1,500 m/s in water and at about 340 m/s in air. As an example, at an air and water interface, energy may be transmitted and reflected.

As an example, marine-based seismic data can include ghost noise due to interactions with the sea surface 205, as an air-water interface. As an example, seismic data may be analyzed for the presence and/or absence of ghost noise. As an example, where a deghosting technique is to be applied, a workflow may include determining a loading order for seismic data that is based at least in part on the presence of ghost noise. For example, consider an approach that provides for rapid assessment of ghost noise through loading and rendering of one or more regions where ghost noise may be present (e.g., at a maximum). In such an example, an operator may readily determine whether deghosting is to be applied and/or how it is to be applied to attenuate ghost noise (e.g., to improve interpretation, etc.).

As an example, each of the sensors 232 may include at least one geophone 234 and a hydrophone 236. In the example of FIG. 2, the at least one geophone 234 can provide for motion detection and the hydrophone 236 can provide for pressure detection. As an example, the data 240 (e.g., analog and/or digital) may be transmitted via equipment, for example, for processing, etc.

In the example of FIG. 2, the equipment 210 may include a system such as the system 250. As shown in FIG. 2, the system 250 includes one or more information storage devices 252, one or more computers 254, one or more network interfaces 260 and one or more sets of instructions 270. As to the one or more computers 254, each computer may include one or more processors (e.g., or processing cores) 256 and memory 258 for storing instructions (e.g., consider one or more of the one or more sets of instructions 270), for example, executable by at least one of the one or more processors. As an example, a computer may include one or more network interfaces (e.g., wired or wireless), one or more graphics cards, a display interface (e.g., wired or wireless), etc.

As an example, pressure data may be represented as “P” and velocity data may be represented as “Z”. As an example, a hydrophone may sense pressure information and a geophone may sense velocity information. As an example, hydrophone may output signals, optionally as digital data, for example, for receipt by a system. As an example, a geophone may output signals, optionally as digital data, for example, for receipt by a system. As an example, the system 250 may receive P and Z data via one or more of the one or more network interfaces 260 and process such data, for example, via execution of instructions stored in the memory 258 by the processor 256. As an example, the system 250 may store raw and/or processed data in one or more of the one or more information storage devices 252.

As an example, a method can include performing a seismic survey that acquires seismic data (e.g., traces, etc.) where such data can build an “image” of a survey area, for example, for purposes of identifying one or more subterranean geological formations. As an example, subsequent analysis of seismic data (e.g., interpretation, etc.) may reveal one or more possible locations of hydrocarbon deposits in one or more subterranean geological formations. As an example, an analysis can include determining one or more characteristics of one or more types of hydrocarbons. As an example, an analysis can include one or more of image generation and attribute generation (e.g., seismic attribute generation, etc.).

As an example, sources may be fired (e.g., actuated) according to a time schedule, a timing sequence, etc. As an example, consider a sequential source firing method that includes firing sources at intervals combined with continuous vessel travel. As another example, consider a simultaneous source firing method that include firing more than one shot at a given point in time (e.g., within a small duration of time such that analysis may consider the shots to be simultaneous). In such an example, sensors may sense information from multiple simultaneous shots and, for example, processing of the sensed information may separate the sensed information into individual source components. As an example, where simultaneous source firing is implemented, “boat time” (e.g., turnaround time, etc.) may be approximately the same or less than a sequential technique (e.g., depending on survey parameters, goals, etc.).

A method for source separation can include acquiring seismic data of a survey that utilizes multiple sources where the seismic data include blended seismic data for a number of emissions from a corresponding number of the multiple sources and associating at least two portions of the blended seismic data correspondingly with at least two of the multiple sources.

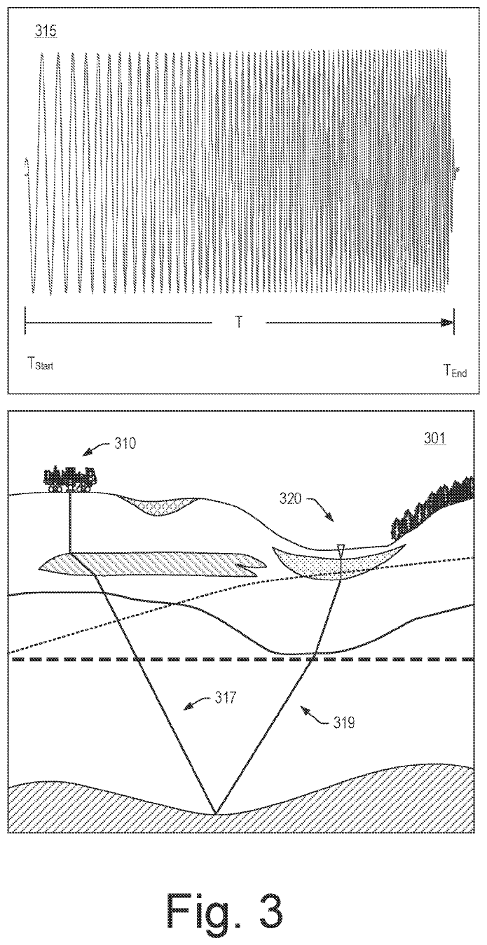

FIG. 3 shows a geologic environment 301, equipment 310, a plot 315 of a frequency sweep as generated by the equipment 310 (e.g., with start and end times), downgoing energy 317 of the frequency sweep, upgoing energy 319 of the frequency sweep, and a sensor 320 (a node as in an array or grid). While FIG. 3 is shown as a land-based survey, various features, actions, etc., may be applied in a marine survey where, for example, seabed sensors are employed.

As an example, data can be data of a simultaneous vibroseis survey that includes seismic energy emissions S1, S2 and S3. Such data may be plotted as a correlated record from a simultaneous vibroseis acquisition where artifacts of an air blast from S1 (cross airwave), chimney noise from S3 and harmonic from S3 (cross harmonic) may be labeled along with a slip time and a record length for S2 (about 5 seconds). In a vibroseis survey, various types of noise may be present such as chimney noise, which may be seen when data are correlated with a survey sweep and visualized (as a column). As to other types of noise, these may include ground-roll and/or air-blast types of noise. In a slip-sweep operations data can be recorded as a mother record where the interval between two consecutive sweeps is referred to as the slip time (see S1 and S2 and slip time).

As to noise attenuation, an averaging approach may be utilized for some types of noise. For example, consider hardwired sensor arrays that attenuate noise by averaging. Such noise attenuation tends to be sensitive to sensor drop-outs and tends to be ineffective against burst noise. As to random noise, a method can include use of a prediction algorithm and/or a projection algorithm, which tend to assume an autoregressive model for the seismic signal and use prediction filter theory to attenuate the noise. Frequency-wavenumber domain velocity filtering and multiscale noise attenuation algorithms are examples of techniques that find use in coherent noise attenuation. In a seismic processing flow, as an example, one or more noise attenuation algorithms might be used to attack different noise types.

As mentioned, seismic data can be in a particular format such as, for example, a cube (e.g., a seismic volume). To understand the concept of a volume of data, consider a room that is divided up into points one foot apart such that each point has an (x, y, z) coordinate and a data value such as temperature at that point. An array that stores the temperature data values can provide temperature as a function of (x, y, z). For a 3D seismic data volume, rather than having a z-axis in strictly in distance, it may be in distance or in time, such as two-way traveltime (TWT), and, rather than temperature at a point, a point can be a seismic amplitude (e.g., an amplitude data value).

A 3D seismic data set can be a box full of numbers, where each number represents a measurement (e.g., amplitude) and where each number has an (x, y, z) position in the box. For a point in the interior of the box, three planes pass through it parallel to the top, front, and side of the box.

Where data values are amplitudes, they may be representing using a scale such as a grayscale, a color scale, etc. In a grayscale representation, dark and light bands in a 2D seismic slice of amplitude with respect to TWT and inline direction may relate to rock boundaries (e.g., reflectors in a subsurface formation).

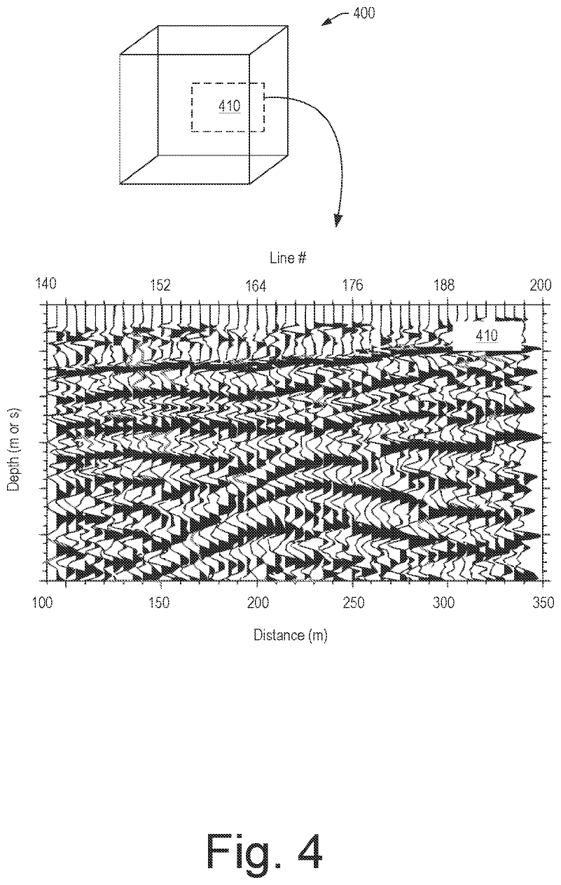

FIG. 4 shows an example of a seismic volume 400 and a seismic slice 410 as accessed from the seismic volume 400 where the seismic slice 410 is presented as amplitude values with respect to depth (e.g., meters or seconds) and distance (e.g., meters) or line number (e.g., “Line #” of a crossline coordinate or an inline coordinate). While the seismic slice 410 is shown to be orthogonal to coordinates of the seismic volume 400, it may be at an angle that does not align with one or more of the coordinates. In such an example, interpolation or another technique may be utilized to generate a slice.

In various instances, seismic data are accessed in a manner that corresponds to coordinates of a seismic volume. For example, an instruction may include coordinates and/or dimensions along coordinate axes to facilitate access of seismic data from a seismic volume.

In the example of FIG. 4, the seismic slice 410 has the appearance of an image where seismic waveforms run vertically, which may be referred to as variable area/wiggle traces. Wiggle traces stems from pen and paper recorders, such as those of a seismograph. As an example, rather than represent seismic waveforms, as mentioned, a scale may be utilized. For example, a scale can be utilized to represent amplitudes. As an example, a blue, white and red color scale may be utilized where gradational blue is utilized for amplitude peaks (e.g., positive values) and gradational red is used for amplitude troughs (e.g., negative values). As an example, a variable intensity scale may be utilized that can provide for presentation of a balanced appearance of positive and negative amplitudes, presentation of data without overlap (e.g., overlapping wiggle traces), presentation of higher amplitude (e.g., more negative or more positive) without mislocation, etc. As an example, a multi-gradational color scheme may help to enhance amplitude events and be particularly applicable to identification of hydrocarbon effects, identification of reservoir reflectors, etc. As an example, a single-gradational color scheme may, on the other hand, enhance low amplitude events and be particularly useful for identification of faults. As mentioned, a variable intensity grayscale scheme may be utilized.

As an example, an enhanced dynamic range color scheme may be utilized, which may facilitate making various types of stratigraphic identifications. For example, consider a cyan-blue-white-red-yellow scheme. Such a scheme may help in identification of gas-oil contact (e.g., a gas bright spot may be higher in amplitude than an oil bright spot).

An interpreter may aim to look for amplitude trends and patterns, low amplitude indications and high amplitude indications. An interpreter may look for character and lateral changes. As mentioned, a color approach may facilitate pairing, identification of problems with data phase and polarity, etc.

While various aspects as may be seen in vertical seismic slices have been mentioned, a scheme may be suitable for facilitating interpretation of a horizontal seismic slice (e.g., at a constant TWT, a constant depth, etc.). As an example, a gradational color scheme may facilitate interpretation of features in a horizontal seismic slice (e.g., trends, patterns, etc.).

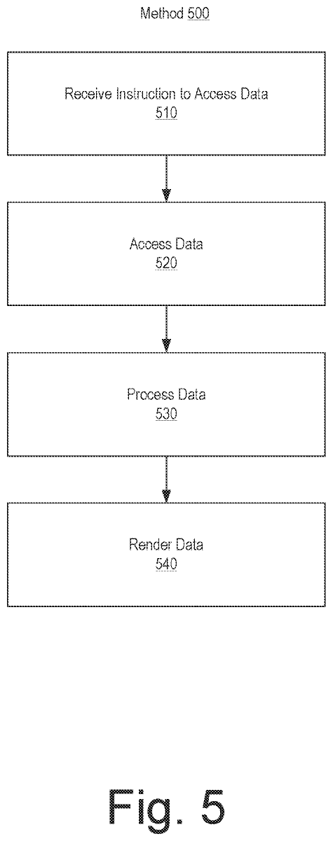

FIG. 5 shows an example of a method 500 that includes a reception block 510 for receiving an instruction to access data, an access block 520 for accessing data, a process block 530 for processing accessed data and a render block 540 for rendering processed, accessed data. Such a method can include one or more communication blocks, for example, consider a transmission block for transmitting accessed data and/or processed data.

As explained, seismic volume analysis can provide for detection of various features such as, for example, horizons, faults, salts, geobodies, etc., that are of interest in subsurface exploration in the oil and gas industry. As explained, seismic volume visualization can be utilized to uncover layered information inside a geologic region, as much of the upper regions of the Earth exist in layers (e.g., sedimentary layers).

As an example, a seismic volume analysis may provide for detection of the presence of hydrocarbons, for example, as may be trapped in one or more subsurface regions. As an example, a seismic volume analysis may provide for identification of a trap. A trap may be a configuration of rocks suitable for containing hydrocarbons and sealed by a relatively impermeable formation through which hydrocarbons will not migrate. Various traps may described as structural traps (e.g., in deformed strata such as folds and faults) or stratigraphic traps (e.g., in areas where rock types change, such as unconformities, pinch-outs and reefs). A trap can be an essential component of a petroleum system. As an example, a trap may be relatively large such that an extent of the trap is not fully captured within a single seismic survey. As an example, evidence of a trap may be present in multiple, different seismic surveys. As an example, one trap may be in fluid communication with another trap. As an example, one or more seismic volumes may provide for trap detection, extent of a trap, number of traps, trap-related features, etc. As an example, consider a seismic workflow that may access one or more seismic volumes for identification of a spill point or spill points. A spill point may be defined as a structurally lowest point in a hydrocarbon trap that can retain hydrocarbons. Once a trap has been filled to its spill point, further storage or retention of hydrocarbons will not occur for lack of reservoir space within that trap where, for example, hydrocarbons may spill or leak out and continue to migrate until trapped elsewhere or emerge at surface.

Various types of seismic volume workflows demand access to seismic volume data structures to provide for visualization. As mentioned, the size of a seismic volume can be substantial and demand considerable resources and/or time for access, processing, transmission, rendering, etc. Thus, size of one or more seismic volumes can be an impediment to a workflow. For example, where a user aims to interpret a geologic region, the user may find that data-related processes slow down interactivity, which may cause the user to operate in a manner that is based on such processes as rate determining. In such an approach, the user may lose focus, concentration, etc., as more opportunities arise for interruptions, distractions, etc. For example, consider a user calling for a seismic slice where the user visually identifies a feature that is believed to extend into at least an adjacent seismic slice. In such a situation, the user may have to wait a considerable amount of time for a call and response, and rendering, to occur for the one or more adjacent seismic slices. Waiting can therefore be a nuisance, which may wear on an interpreter and decrease the interpreter's productivity and enjoyment.

As mentioned, a seismic volume can be greater than several gigabytes and may be more than one hundred gigabytes (e.g., or even a terabyte or more). Loading such large seismic volumes, and analyzing them, can be considered a high-performance computing (HPC) task. As mentioned, loading of a seismic volume or seismic volumes can affect user experience where there is beyond a reasonable delay for loading.

As an example, a method can improve user experience through intelligent loading. As explained, one or more types of approaches may be utilized for intelligent loading that can include determining a loading order (e.g., loading priority, etc.).

Performant and efficient visualization of 3D seismic datasets is a vital aspect of numerous subsurface processing, interpretation and modelling workflows supporting discovery, analysis and prospecting of subsurface geology. Such datasets are both numerous in quantity and ever increasing in their size typically, on the order of gigabytes to terabytes per individual dataset. Seismic rendering techniques can include utilizing a series of vertical and horizontal planes, fixed to an orthogonal survey geometry (e.g., inline, xline and timeslice or depth slice), with each individual data volume demanding its own individual set of intersection planes to enable visualization of seismic images.

Whilst optimized for easily accessing data, fixed geometries rarely capture subsurface heterogeneity, and pose several imitations when arbitrary interrogation of data is desired. Random interrogation of data is possible but at the cost of performance. Across multiple sections with, random orientations that are dynamically manipulated within large scale data sets, these performance losses add up and contribute to a degraded and sometimes frustrating user experience. As workflows involving seismic data can demand considerable attention (e.g., to visual details), user experience that degrades an ability to be attentive can adversely impact a workflow (e.g., in terms of time, resources, accuracy of results, etc.).

Additionally, typical geophysical interpretation workflows generate numerous derivate data through the application of one or more of various techniques (e.g., signal processing, machine learning, etc.) to produce volume attributes. Such workflows often demand that different data volumes are co-rendered with one another to provide greater insight to assist data interpretability (e.g., consider one or more structural features that may span multiple data volumes, etc.). To create such displays through use of inline and xline specifications, demands that each volume is to have matching geometric extents, limiting the types of data that can be rendered together (e.g., on a common display, etc.). As explained, each seismic volume can have its own inline and xline specifications, which may be a direct result of how a seismic survey has been set up and performed.

As an example, a framework can provide an “any planes” type of approach to seismic visualization and rendering. Such a framework may utilize one or more surfaces, which may be multidimensional, flat, curved, flat and curved, etc. Thus, while various examples mention “planes”, a framework can provide for rendering visualizations for non-planar surfaces, objects, etc.

As an example, a framework can be utilized to visualize 3D seismic reflection data and/or associated derivate volume data in one or more formats such as, for example, the ZGY format, in a manner that can be decoupled from constraints of specific survey geometries. Such a framework may be used by geoscientists, geophysicists and associated subsurface practitioners for the efficient visualization, machine-based manipulation, co-rendering and interpretation of multiple 3D seismic reflection and derivate data (e.g., available in ZGY or open ZGY formats), wherever trace data are present irrespective of parent survey geometry. A framework can provide for implementation of one or more methods to visualize seismic and derivate volume data wherever trace data are spatially present. By grouping data inputs to co-render, a framework can reduce demands such as demands to duplicate intersections and other objects.

As explained, visualization tends to be constrained by seismic volume geometries, defined during data acquisition, limiting the visualization of data on planes or intersections to a single volume requiring, duplication and manipulation of co-rendering volumes to have dimensions that match exactly to render the data.

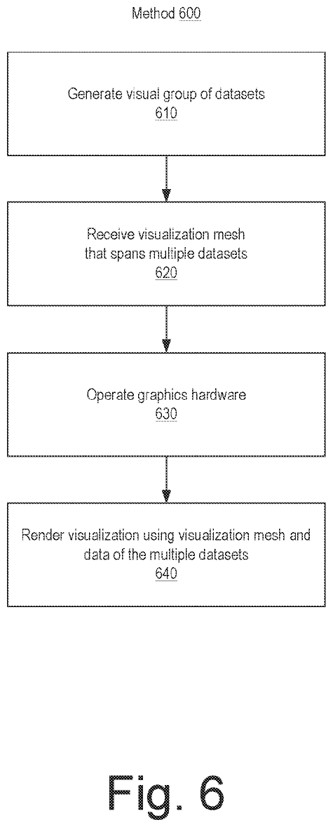

FIG. 6 shows an example of a method 600 that can be implemented by a framework where the method 600 can include a generation block 610 for generating a visual group of datasets, a reception block 620 for receiving a visualization mesh that spans multiple datasets, an operation block 630 for operating graphics hardware and a render block 640 for rendering a visualization using the visualization mesh and data of the multiple datasets.

As an example, graphics hardware can provide for acquiring one or more parameters as to pixels of a display or displays. As an example, such parameters may be accessible via one or more application programming interface (API) calls, which may be provided by an operating system or other type of application. In such an example, a method can include discovering display properties, which may be utilized in one or more manners to control rendering of one or more visualizations (e.g., consider use in a tree approach for multi-scale resolution).

As an example, a computational framework may utilize source and/or trace locations, which can be part of a method for processing seismic data, and knowing the location of the processed data with respect to other data. As an example, seismic coordinates may be supplied as geographic coordinates and/or grid coordinates. As an example, a coordinate reference system (CRS) definition may be utilized, which may be, in the SEG-Y format, in the Binary Header, the Extended Textual Headers and the Trace Headers.

A trace header can include various types of information. For example, consider the following from the SEG-Y format as to trace identification codes: −1=Other; 0=Unknown; 1=Seismic data; 2=Dead; 3=Dummy; 4=Time break; 5=Uphole; 6=Sweep; 7=Timing; 8=Waterbreak; 9=Near-field gun signature; 10=Far-field gun signature; 11=Seismic pressure sensor; 12=Multicomponent seismic sensor—Vertical component; 13=Multicomponent seismic sensor—Cross-line component; 14=Multicomponent seismic sensor—In-line component; 15=Rotated multicomponent seismic sensor—Vertical component; 16=Rotated multicomponent seismic sensor—Transverse component; 17=Rotated multicomponent seismic sensor—Radial component; 18=Vibrator reaction mass; 19=Vibrator baseplate; 20=Vibrator estimated ground force; 21=Vibrator reference; 22=Time-velocity pairs; and 23 to N=optional use, (maximum N=32,767). As another example, consider trace value measurement units: −1=Other; 0=Unknown; 1=Pascal (Pa); 2=Volts (v); 3=Millivolts (mV); 4=Amperes (A); 5=Meters (m); 6=Meters per second (m/s); 7=Meters per second squared (m/s²); 8=Newton (N); and 9=Watt (W).

As an example, a computational framework may perform loading and/or processing based on one or more parameter values that may be in a request and/or in a seismic volume (e.g., header, etc.). As mentioned, various types of rendering styles can be utilized such as trace wiggles, color scale, grayscale, etc. Where units are indicated, the seismic data may be of a particular type (e.g., marine, land, etc.) where a particular type of rendering style is available, more suitable, etc. As an example, a method may include accessing header information and loading and/or processing seismic data based at least in part on trace value measurement units.

In the SEG-Y format, Trace Data follows each Trace Header. The seismic data in a SEG-Y formatted file can be organized into ensembles of traces or as a series of stacked traces. When the trace data are organized into ensembles of traces, the ensemble type may be identified (e.g., Binary File Header bytes 3229-3230). As to some examples of a trace sorting code (e.g., type of ensemble), consider: −1=Other; 0=Unknown; 1=As recorded (no sorting); 2=CDP ensemble; 3=Single fold continuous profile; 4=Horizontally stacked; 5=Common source point; 6=Common receiver point; 7=Common offset point; 8=Common mid-point; and 9=Common conversion point.

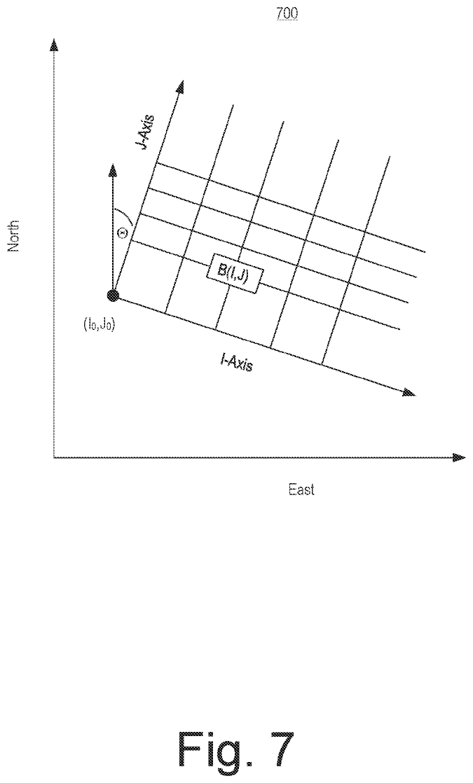

FIG. 7 shows an example of a bin grid representation 700 that can be utilized for organizing, storing, loading, processing, etc., of seismic data. In the SEG-Y format, the Bin Grid Definition stanza defines a bin grid including its relationship to a projected CRS (e.g., map grid). The projected CRS can be defined in a Location Data stanza. The content of the Bin Grid Definition stanza may follow the provisions of the UKOOA P6/98 v3.0 format. The bin grid is the relative coordinate framework which defines a matrix of evenly spaced points referred to as the bin nodes. The term bin node is used instead of the term bin center and refers to the locations where the bin grid lines intersect. The bin grid is defined by a pair of orthogonal axes designated the I and the J axes, with the I axis rotated 90 degrees clockwise from the J axis. The order of specifying bin grid coordinates can be the I value followed by the J value (I, J) (see, e.g., B (I, J)). The choice of I, J axes is made to alleviate confusion between bin grid (I, J) and map grid (E, N) coordinates. Axes may be labeled by as appropriate, for example, consider such terms as Inline and Crossline, Row and Column, x and y, Line and Trace. For the purpose of data exchange through the SEG-Y format reference is to the I and J axes. Coordinates of three check nodes can be utilized to permit numerical verification of the bin grid definition parameters. For example, two of these points can be taken on the J axis and a third point remote from the J axis within the area of coverage.

As explained, a format may provide for bricking of data such that data are amenable to being handled in a tree manner. For example, consider a quadtree, an octree, etc. An octree is a tree data structure in which each internal node has eight children. Octrees can be utilized to partition a three-dimensional space by recursively subdividing it into eight octants. Octrees can be a three-dimensional analog of quadtrees. As an example, a framework can provide for processing of data, structuring data, accessing data, etc., using one or more types of tree structures.

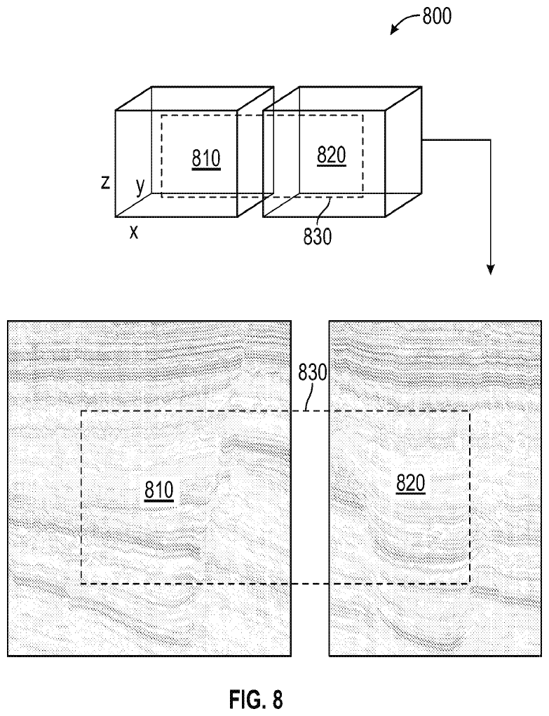

FIG. 8 shows an example of a visual group of two seismic volumes 800, where one volume is labeled 810 and where another volume is labeled 820 where the volumes may be referred to as datasets 810 and 820. In the example of FIG. 8, a 2D plane 830 is shown, which can be a visualization mesh. In FIG. 8, a rendering is shown using a dashed line to represent the 2D plane 830 to demonstrate what portion of the datasets 810 and 820 are to be rendered. In the example of FIG. 8, note that the datasets 810 and 820 are not overlapping; rather, a gap exists between them. As an example, the method 600 of FIG. 6 can handle rendering of data (e.g., raw and/or attributes) for multiple datasets, whether or not the multiple datasets overlap or not. Such a method can include accessing a rendering engine that includes texture and shader features. Such a method may implement one or more mapping techniques such as, for example, one or more UV mapping techniques.

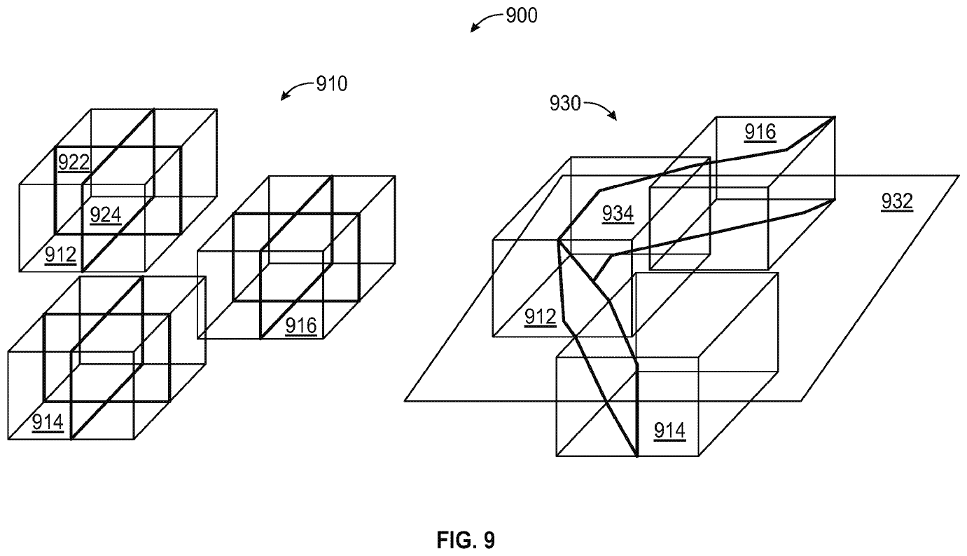

FIG. 9 shows examples of datasets 900 as to two scenarios 910 and 930 where a group of three datasets 912, 914 and 916 may be defined by individual inline and xline geometry corresponding to survey geometries for each of the three datasets. As shown, the three datasets 912, 914 and 916 are offset from one another in space, with or without overlap. As shown, the scenario 910 can handle solely orthogonal slices where each slice is solely within a single one of the datasets, for example, the dataset 912 includes orthogonal slices 922 and 924 within the confines of the dataset 912. As to the scenario 930, it can include an arrangement of the datasets 912, 914 and 916 that may correspond to an actual physical space such as that of a basin that has been subjected to multiple seismic surveys that have generated at least the three datasets 912, 914 and 916. As shown, two or more of the datasets 912, 914 and 916 may overlap or not overlap, with or without a gap. In the example scenario 930, a plane 932 may be received or otherwise generated that intersects two or more of the datasets 912, 914 and 916. Also shown in a 3D surface 934 that can intersect two or more of the datasets 912, 914 and 916 as set forth in a domain, which may correspond to a physical space (e.g., a basin, etc.).

In FIG. 9, the scenario 930 provides for expedited viewing of multiple datasets using one or more objects that can intersect one or more of the datasets 912, 914 and 916. In such an example, an object can be a visualization mesh that snakes through a domain to intersect multiple datasets. In such an approach, the object may intersect one or more datasets where at least a portion of a well is present. In such an example, a rendering may include one or more types of data such as, for example, seismic data and well data (e.g., one or more well logs, etc.). As an example, an object may conform to a flow field resulting from a fluid flow simulation. For example, consider a framework that can analyze simulation results to determine contours of flow fields, temperature fields, pressure fields, etc. In such an example, an object may be defined using such simulation results. For example, consider an object that intersects two wells in two different datasets where flow can be visualized as flowing to each of the wells. In such an example, a rendering may include seismic data along with flow or flow related data, which may include property data (e.g., permeability, composition, etc.).

As explained, an approach that relies on inline and xline harmonization as in the scenario 910 can be limiting compared to an approach that can decouple aspects of datasets and visualization tasks as in the scenario 930; noting that the scenario 930 can effectively couple datasets in a visualization using an intersecting object or objects.

As an example, a method such as the method 600 of FIG. 6 can provide for generation and/or reception of a visualization mesh that extends into more than one dataset without inline and xline harmonization. For example, a visualization mesh may not have a constraint as to adherence to an inline direction or a xline direction of one or more datasets. In FIG. 9, a harmonization approach as in the scenario 910 may be limited to slices as indicated (see, e.g., 922 and 924) for each of the individual datasets 912, 914 and 916; whereas, a decoupled approach as in the scenario 930 can provide for one or more 2D and/or 3D surfaces that may span multiple datasets. For example, as to the graphics in the scenario 930, a framework can provide for rendering of a textured visualization mesh that corresponds to a multidimensional surface where texture corresponds to data. As explained, a framework may implement an “any planes” type of approach to visually display data wherever those data are present by using a single mesh object or more that can pass through two or more individual volumes to display the texture, independent of the input geometry; noting that a mesh object may be planar, in part planar, curved, in part curved, etc.

As explained, a framework can provide for efficiently loading seismic volume data from various sources and rendering of portions of such data in an approach that utilizes dynamic resolution rendering to a display (e.g., a computer screen). From the user's point of view, seismic data can be organized in a structure called a visual group that includes source data descriptions and a table mapping seismic values to a color, etc. In the visual group description, there may also be a description of how a number of seismic volumes are to be mixed in case of overlap. As an example, if there is no overlap, colors read from a specified color table may be rendered on a display. As an example, a visual group can be assigned to one or more 3D objects in a scene and whenever a 3D object intersects one of the volumes specified in the visual group, the corresponding seismic values (e.g., raw data, attributes, etc.) can be rendered on the object in the intersecting region.

As an example, a framework can handle volume data (voxels in 3D) where geometry on which these volumes are rendered are handled separately and computations for which samples from the volumes will be rendered are handled using graphics hardware (e.g., one or more GPUs).

As explained, volumes may be split into bricks of 643 samples and stored in a bricked format such as the ZGY format. The ZGY format represents a tree-structure where the full resolution bricks are leaf nodes (at Level-Of-Detail, LOD 0) and internal nodes hold bricks with averaged data in a lower resolution (LOD>0). For instance, when accessing data at LOD 1, each sample refers to an average of 8 samples in the full resolution. At LOD 2, the single average of 64 samples takes up the same space as the collection of the 64 samples did at LOD 0. This structure of LODs is an octree. As explained, where geometry is not separated, to show seismic intersections, a framework generates a 2D array of samples by calculating which samples are intersecting the 2D intersection geometry and then draws the intersection geometry with a simple 2D texture and UV mapping. One intersection geometry can intersect volume data from one single survey geometry and if several volumes are to be drawn onto the same intersection geometry, they have a constraint that they are to come from the same survey geometry.

In various examples, a reason for organizing the seismic volume data in an octree can be that, for reasonably sized seismic volumes, it is generally not practical to have sufficient memory or hardware that can fit the entire volume (e.g., in the memory of the graphics hardware). As an example, a framework can choose a subset of a volume or reduce the size by creating a smaller averaged version. For example, a framework that can implement the method 600 of FIG. 6 can utilize averaging and leverage the fact that the number of pixels on a computer screen is limited, and one pixel is limited to rendering a single color. For example, a HD screen (2D) has 2,073,600 pixels and with 32 bits for each color, which demands roughly 8 MB. This means that for a 2 TB seismic volume in 3 dimensions, in theory, a framework can render to a HD screen a maximum of 8 MB of the 2 TB seismic volume at a time. Through use of octrees, a framework can determine which parts of the data to load and in which resolution it makes sense to load where a framework can load data with higher resolution where desirable (e.g., close to the rendering camera) and lower resolution elsewhere (e.g., further away from the rendering camera). Such an approach can result in an image with varying resolution for a single rendering result (e.g., multi-resolution rendering). As an example, a framework may operate according to rules and/or parameters, which may be automatically determined, user defined, set by default, etc. For example, a framework may assess size of a visualization mesh and make determinations as to camera location and view to determine resolutions in multi-resolution rendering. In such an example, the framework may account for memory, GPU, etc., capabilities to make the process more efficient (e.g., real-time, low latency, etc.).

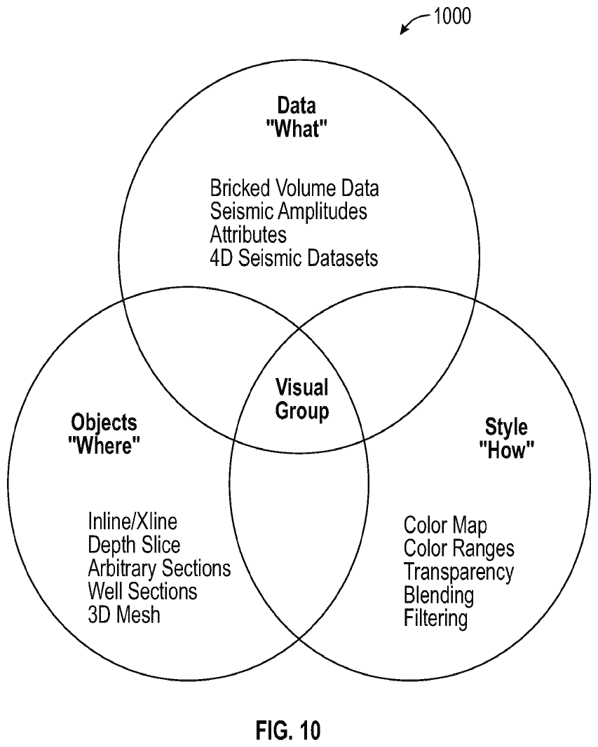

FIG. 10 shows an example of a graphic 1000 that specifies various aspects of a structure for use in rendering. As explained, a method can include defining a structure that can be referred to as a visual group. Such a structure can include one or several seismic volumes and corresponding color maps. A color map can be used on graphics hardware to map a value in a seismic volume (e.g., represented as floating point values) to a single color on a color scale. A visual group may also include information about how to blend colors from multiple volumes if they overlap. A framework may provide for visual group generation, for example, by selection of datasets and rendering of one or more GUIs to provide for assessment of visual group properties, etc. As shown in the example of FIG. 10, a visual group can combine a number of input datasets and specify how to view and co-render data (e.g., independently, in combination, etc.). A visual group can be associated with a type of object to display a resultant texture.

As explained, a framework can provide for decoupling input volumes and intersection geometry, which can be a complete decoupling. As an example, a rendering engine may be or include features of a gaming engine. As an example, a method can include: setting up a visual group with seismic volumes and color maps; setting up data access and providing volume data in bricked format from one or more sources such as remote cloud storage or local ZGY file; setting up shader code to instruct graphics hardware as to how to render volumes defined in the visual group; and setting up a 2D geometry or 3D surface with manipulation tools.

As an example, shader code running on graphics hardware can be assigned to an intersection geometry with input: transform matrices for each volume; color scale texture for each volume; volume data in the form of a 3D texture for each volume; and mixing function, as appropriate.

An example of code for a mixing function is presented below:

```
if(outside1 && outside2 && outside3 && outside4) outColor =
outsideColor;
else{
float bgr = 0;
float bgg = 0;
float bgb = 0;
float fraction1 = backgroundBlendFraction;
float fraction2 = 1.0-backgroundBlendFraction;
if(bg1 && !bg2) fraction1 = 1;
if(!bg1 && bg2) fraction2 = 1;
if(!outside1 && bg1){
    bgr=color1.r*fraction1;
    bgg=color1.g*fraction1;
    bgb=color1.b*fraction1;
}
if(!outside2 && bg2){
    bgr+=color2.r*fraction2;
    bgg+=color2.g*fraction2;
    bgb+=color2.b*fraction2;
}
if(!outside3 && overlay1 && normValueOverlay1>overlayRange1.x &&
normValueOverlay1<overlayRange1.y){
    bgr=color3.r;
    bgg=color3.g;
    bgb=color3.b;
}
if(!outside4 && overlay2 && normValueOverlay2>overlayRange2.x &&
normValueOverlay2<overlayRange2.y){
  bgr=color4.r;
  bgg=color4.g;
    bgb=color4.b;
}
outColor = float4(bgr, bgg, bgb, 1.0);
}
```

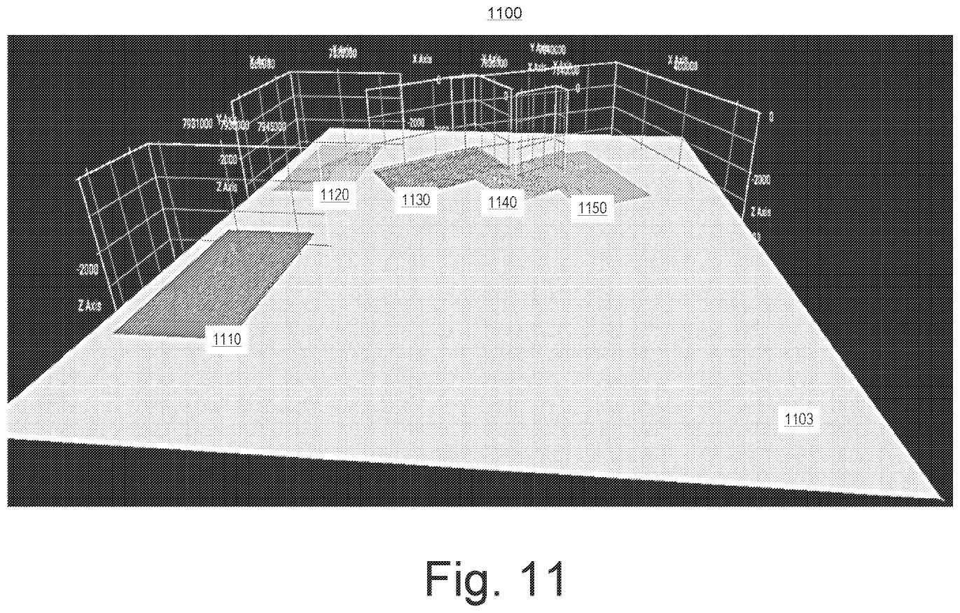

FIG. 11 shows an example graphic 1100 that may be rendered to a display where the example graphic 1100 is for multiple input volumes 1110, 1120, 1130, 1140 and 1150 as visualized on a single intersection object 1103 (e.g., a plane that intersects each of the input volumes 1110, 1120, 1130, 1140 and 1150). As an example, a framework can provide for an intersection to be scaled to be a desired size and moved freely between the different data sets. In contrast, a coupled technique would demand at least 5 independent intersection objects to enable simultaneous visualization of the data of the input volumes 1110, 1120, 1130, 1140 and 1150. In the example of FIG. 11, a user can see renderings for each of the input volumes 1110 to 1150 (e.g., datasets) where gaps exist and where overlap exists. In such an approach, a user may be able to perform interpretation (e.g., picking, tracking, etc.) in an improved manner as one or more common structures may run throughout a basin as imaged by different seismic surveys. As explained, a framework may provide for rendering of data from multiple data volumes where two or more of the data volumes differ with respect to coordinates (e.g., inline and/or xline), which can be due to acquisition of data or acquisition of data from which data volumes are derived.

In the example of FIG. 11, the plane 1103 and/or one or more other objects (e.g., as meshes, etc.) may be generated automatically, for example, via one or more techniques. As explained, a well or wells may be drilled in a region or regions where well log data are available (e.g., via logging operations in the well or wells). As an example, log data may be utilized to generate a shape of an object that may span multiple data volumes. As to the plane 1103 of FIG. 11, it may be generated using log data from one or more wells where the log data indicate a depth of a layer or layers that may provide for identification of one or more types of subsurface structures. As explained, an object (e.g., a mesh) may be of a shape other than a plane. As an example, an object may be shaped in a manner based on depths indicated by log data from one or more wells.

As an example, an object may be generated using one or more techniques involving implicit functions. For example, an implicit function approach may be utilized to represent and/or further elucidate stratigraphy of a region. In such an approach, an implicit function may include values that may approximately represent surfaces, such as, for example, one or more horizons. As an example, a framework may provide for visualization of results from an implicit function analysis and/or other analysis of stratigraphy where multiple, different data volumes are utilized. In such an approach, a graphical user interface (GUI) that includes one or more multiple data volume-based renderings may provide for user interaction to adjust one or more points (e.g., as to time, depth, etc.), which may, in turn, provide for more accurate representation of surfaces using an implicit function approach. In such an example, a more accurate earth model may be generated for a subsurface region, which, in turn, may provide for more accurate simulation results (e.g., of pressure, fluid flow, temperature, geomechanics, etc.).

As explained, an object (e.g., a mesh) may be generated in a data-driven manner, which may include utilization of one or more machine-learning models. As explained, an object may be utilized as part of a rendering process to visualize data from multiple data volumes where each of the multiple data volumes may have its own coordinate specifications (e.g., inline and xline specifications, etc.).

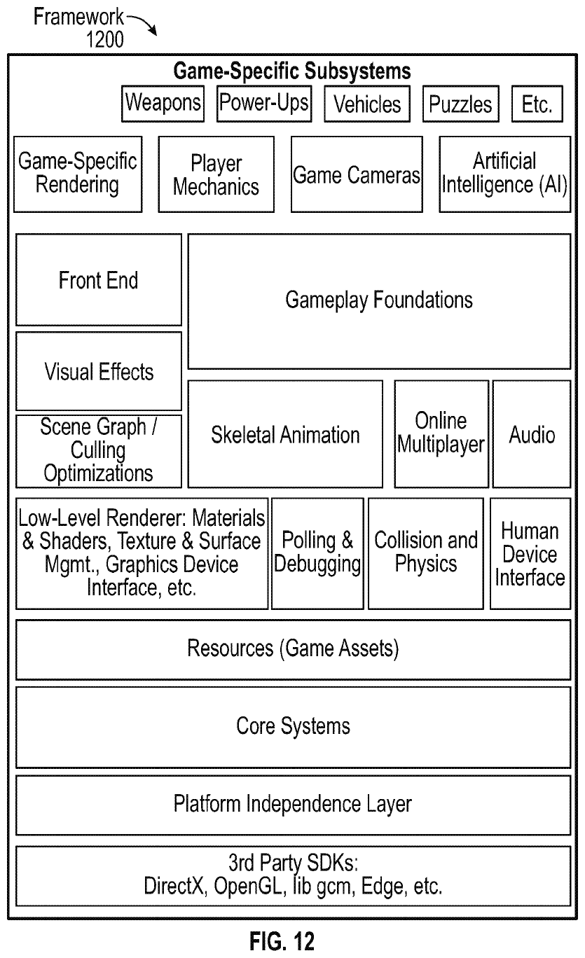

FIG. 12 shows an example of a framework 1200 that includes various features, including, for example, shader features and texture features. The framework 1200 includes various features of the Unity gaming framework (Unity Technologies, San Francisco, California). As shown, the framework 1200 includes renderer features, including cameras, textures, shaders, etc. While the example framework 1200 includes various labels pertaining to gaming, such features may be adapted, as appropriate, for purposes of rendering of seismic volumes, etc.

As to gaming, an avatar may be generated using an animation program where a texture or textures may be applied. For example, consider dressing an avatar by assigning different materials (e.g., textures) to different portions of the body of the avatar where, for example, as the avatar moves, the materials can follow (e.g., be rendered to provide an animated, dressed avatar). In such an approach, the different materials (e.g., textures) may be predefined in a library and agnostic to coordinates to readily fit a portion of an avatar. For example, consider one or more hair textures that may be assigned to a hair portion of an avatar.

As to a framework for handling workflows associated with data volumes, which may be seismic data volumes, as explained, such data volumes are inherently related to acquisition parameters and, for example, a structural subsurface feature may be evidenced in multiple data volumes, which may overlap, be spaced apart, oriented differently, have different inline and/or xline specifications, etc. An object (e.g., a mesh) may be generated automatically, semi-automatically and/or manually for a particular workflow task. In such an example, a framework may generate a rendering where a texture-based approach determines what data from each of the data volumes are to be rendered to the object, for example, to more readily assess one or more subsurface features.

As an example, one or more features of one or more frameworks may be utilized. For example, consider the DIRECT3D framework (Microsoft Corporation, Redmond, Washington), which is a graphics application programming interface (API). Such a framework can use hardware acceleration if it is available on a graphics card, allowing for hardware acceleration of a 3D rendering pipeline. The DIRECT3D framework exposes advanced graphics capabilities of 3D graphics hardware, including Z-buffering, W-buffering, stencil buffering, spatial anti-aliasing, alpha blending, color blending, mipmapping, texture blending, clipping, culling, atmospheric effects, perspective-correct texture mapping, programmable HLSL shaders and effects. As an example, high level and/or low level shaders may be utilized as part of a graphics hardware platform.

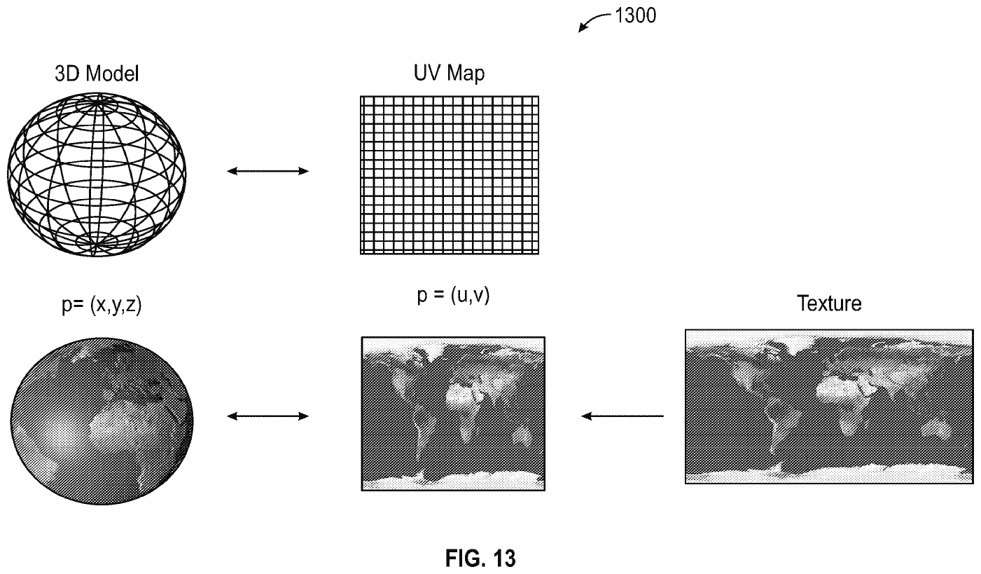

FIG. 13 shows example processes 1300 associated with UV mapping. As shown, a 3D model can be provided and transformed into a 2D map where a texture (e.g., an image, data, etc.) can be associated with the 2D map, which may then be transformed back to the 3D model. In such an approach, a texture can be applied to a 3D model, which can be a surface, a volume, etc. As an example, the framework 1200 can include features for UV mapping.

As an example, a framework can provide a rendering engine that includes features for one or more cameras that display what a user wants to see where a camera can be rendered as a graphic (e.g., a rectangle, etc.) floating in a scene. As an example, a rendering engine can provide one or more particle systems that can simulate motion. As explained, a framework can provide for use of meshes, which may be 2D, 3D or 4D. As an example, a rendering engine can provide one or more types of meshes as graphics primitives. As an example, a framework may provide modeling tools and/or access to modeling tools for mesh generation and/or for mesh access. As explained, a rendering engine can provide for use of one or more textures, which can be generated as images (e.g., image files, video files, etc.) that can be rendered using a mesh or meshes. As explained, a rendering engine can provide for one or more shaders. A shader can be a hardware implemented technique that performs various tasks such as, for example, computing views with respect to a camera or cameras. As an example, a framework may include one or more built in shaders and/or provide one or more customized shaders.

As an example, a mesh may have a name and include properties such as, for example, number of vertices in the mesh, type and number of faces in the mesh (e.g., consider triangles to define faces), number of blend shapes in the mesh (e.g., 0 or more), number of sub-meshes in the mesh (e.g., 0 or more), names of one or more UV maps in the mesh, and, for skinned meshes, name of a skin weights property.

As an example, a mesh may be viewed, for example, using a checkerboard texture applied to the mesh to visualize how the mesh's UV map applies textures. As an example, a UV layout view may be used to display how the vertices of the mesh are organized in an unwrapped UV map.

As to UV mapping, it is a multidimensional modeling process of projecting a 2D image to a model's surface for texture mapping. For example, consider a mesh model where a 2D image can be projected onto the mesh model. In UV mapping, U and V denote the axes of a 2D texture as the coordinates X, Y, and Z may already be used to denote the axes of an object in model space, while W (in addition to XYZ) may be used in calculating quaternion rotations. UV texturing permits polygons that make up a multidimensional object to be painted with one or more surface attributes. An image may be a UV texture map. UV mapping process involves assigning pixels in an image to surface mappings on a polygon, which may be performed by programmatically copying a triangular piece of an image map and pasting it onto a triangle on an object. UV texturing may be utilized as an alternative to projection mapping (e.g., using any pair of the model's X, Y, Z coordinates or any transformation of the position); it maps into a texture space rather than into the geometric space of the object. A rendering computation can use the UV texture coordinates to determine how to paint a multidimensional surface.

As an example, a method may include generating a height map. For example, consider projecting values of a texture as heights along a dimension that is generally orthogonal to a mesh. In such an example, a user may see more precisely how values vary over the mesh.

As mentioned, a framework may utilize one or more shaders. A shader can be a program executable on a graphics processing unit (GPU). A framework may include different types of shaders. For example, shaders that are part of a graphics pipeline may be utilized to perform calculations that determine the attributes of pixels to display. A shader may be implemented as a shader object (e.g., an instance of a shader class). A compute shader can perform calculations on a GPU, which may be outside of a base graphics pipeline. As an example, a shader may be a ray tracing shader that can perform calculations related to ray tracing.

As an example, a shader may be built using a shader graph tool. For example, consider a tool that can provide for dragging and dropping various features, editing features, etc., to construct a process or processes that can be executed as least in part using one or more GPUs. In such an example, a shader may be built and stored for use in an on-demand manner.

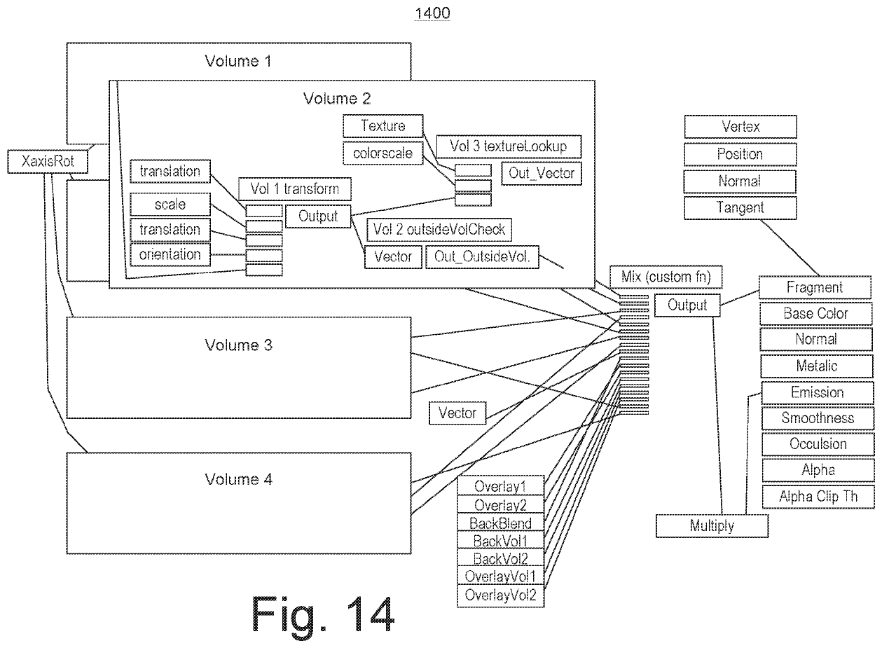

FIG. 14 shows an example of a shader graph 1400 that corresponds to a utility of the aforementioned Unity gaming framework, which includes shader capabilities. Specifically, the Unity gaming framework provides a utility referred to as Shader Graph, which can generate a graph such as the shader graph 1400 of FIG. 14. The Shader Graph utility allows for visualization of shaders and, for example, rendering of results in real-time. For example, the Shader Graph utility allows for building shaders graphically by creating and connecting nodes in a graph network. In such a graph network, each node may have a built-in preview that enables a user to see output (e.g., as may be generated in a step-by-step manner). Such a graph network can include an overall preview that allows a user to see the end results of a shader. As an example, if the shader is applied to a model in a scene (e.g., an avatar in a scene), the shader can update instantly when saved, providing a split-second update. As explained, nodes in a graph network can represent data about objects to which one or more materials are applied, which may include one or more functions, procedural patterns, etc. The Shader Graph utility allows a user to add one or more custom functions (e.g., Custom Function node) and/or to wrap one or more nodes in a subgraph to expand a node library with custom computations. The Shader Graph utility allows for visualization of relationship between operations that take place in the vertex stage (e.g., when attributes of polygon vertices are computed) and the fragment stage (e.g., when computations are made to see how pixels between vertices appear).

As an example, a shader network may be utilized to generate one or more shaders for execution on graphics hardware, for example, to perform one or more actions of a method such as the method 600 of FIG. 6. In the example of FIG. 14, information for four different volumes are shown as Volume 1, Volume 2, Volume 3 and Volume 4. For convenience, an enlarged view is shown for Volume 2, which may be akin to details for the other three volumes.

As an example, a framework may provide for automated shader generation given an object (e.g., a mesh) and multiple data volumes. In such an example, the shader may be represented in a graph network form and/or one or more other forms. As an example, a framework may render an object using shader technology and data from each of multiple data volumes where the object extends into at least a portion of each of the data volumes. As explained, an object may be generated in one or more manners (e.g., automatically, semi-automatically, manually, etc.) and, for example, a rendered object with data may be subjected to analysis, for example, consider feature tracking, etc., for one or more purposes (e.g., subsurface structure identification, stratigraphy, presence of hydrocarbons, etc.).

As an example, graphics hardware can perform a process such as the following process:
1. For each fragment (pixel) on the screen, if a ray cast from the pixel into the scene intersects the intersection geometry then for that point in space P:
   1.1 For each volume V in the visual group VG:
      1.1.1 If P is inside the bounding box of V:
         1.1.1.1 Find indices I, J, K in V by a linear mapping from world space X, Y, Z to in-volume space (this is possible because the values in the volume is defined in a regular grid)
         1.1.1.2 Read out the value from V and use that to read a color from the corresponding color map. If the octree does not have the sample ready in memory, schedule it for retrieval and load the sample in a lower resolution.
   1.2 The colors returned for each volume is then mixed by 1. average or 2. overlay

As explained, a decoupled approach to visualization of data in multiple volumes can keep the geometry on which values are drawn from a seismic volume (intersection geometry) separate from the seismic volumes themselves. Determining which values to draw (e.g., render) can be decided upon by graphics hardware, for example, just prior to rendering, which allows for use of various desired geometries in various desired orientations. As an example, a framework can use multiple volumes that do not share a common survey geometry and draw them on a common intersection geometry (see, e.g., the graphic 1100 of FIG. 11).

As explained, a framework can provide for visualization of seismic trace data unassociated with specific seismic survey geometries. Such a framework can provide for combining multiple datasets, and enabling the visualization of seismic data irrespective of the geometry or spatial location of the data. Visualization may be performed wherever objects intersect trace data, irrespective of parent geometry. Co-rendering may be performed wherever data are spatially present, without having to match geometries. As an example, visual grouping of input data objects can provide for manipulation and customization of how data are combined and presented to a user.

A framework may be utilized in one or more workflows that include seismic rendering and visualization of multiple datasets. For example, consider various volume rendering workflows across seismic processing, interpretation and quantitative interpretations. As an example, a framework may provide for quality assessment of seismic data in multiple volumes. For example, consider automatically highlighting data as to quality, which may include highlighting higher quality data over lesser quality data where such data may be in different volumes. For example, a GUI can provide for selection of how data are handled and rendered from multiple datasets such that a user can readily visualize aspects of data quality. As explained, an interpretation process may include picking to reconstruct subsurface structures, which may be suitable for model building and, for example, simulation.

As an example, a framework may assist a user in picking (e.g., interpretation). For example, consider the graphic 1100 of FIG. 11 where a user may aim to identify a subsurface structure in one dataset using information from one or more other datasets. In a coupled approach, the user may have to generate two separate visualizations and then compare; whereas, in a decoupled approach, the user may generate a mesh (e.g., object) that spans a particular spatial region in a particular manner such that a subsurface feature of interest is included within the mesh. In such an example, rendering to the mesh can provide the user with a view of the subsurface feature across multiple datasets, which can facilitate picking (e.g., interpretation).

As an example, a framework can provide for combining spatial inconsistent datasets into a single visualization. Such an approach can expand use for inclusion of dataset that may otherwise be deemed unsuitable. In various instances, seismic datasets may span years, if not a decade or more. As such, it may be difficult to harmonize such datasets. With a decoupled approach, constraints can be relaxed to allow for use of varied datasets, which may include seismic data and/or other types of data.

As explained, a framework can provide for easier management of seismic data and associated visualization thereof. Such a framework can provide a faster approach to viewing large quantities of seismic over geographical disparate locations. Such a framework can provide a versatile approach to seismic rendering and visualization to support numerous domain workflows through a single visualization system.

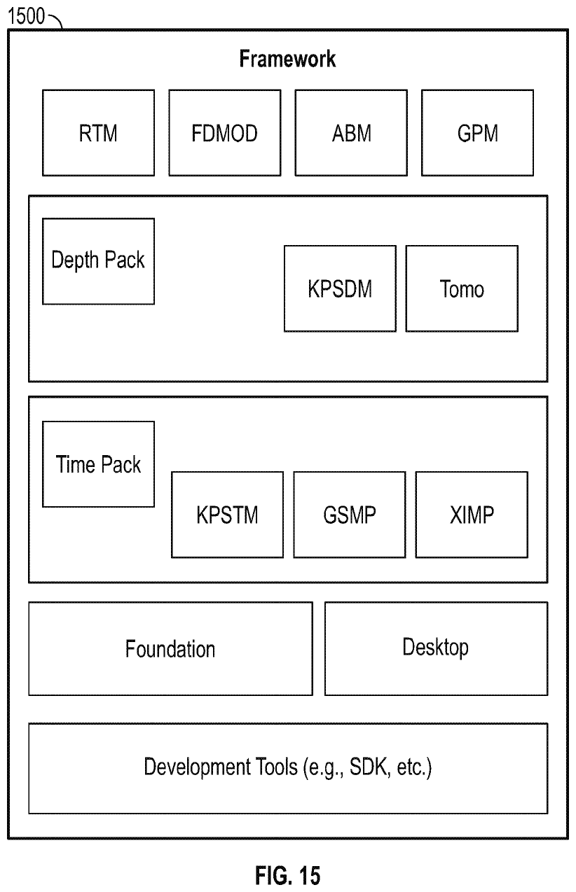

FIG. 15 shows an example of a computational framework 1500 that can include one or more processors and memory, as well as, for example, one or more interfaces. The computational framework of FIG. 15 can include one or more features of the OMEGA framework (SLB, Houston, Texas), which includes finite difference modelling (FDMOD) features for two-way wavefield extrapolation modelling, generating synthetic shot gathers with and without multiples. The FDMOD features can generate synthetic shot gathers by using full 3D, two-way wavefield extrapolation modelling, which can utilize wavefield extrapolation logic matches that are used by reverse-time migration (RTM). A model may be specified on a dense 3D grid as velocity and optionally as anisotropy, dip, and variable density.

As shown in FIG. 15, the computational framework 1500 includes features for RTM, FDMOD, adaptive beam migration (ABM), Gaussian packet migration (GPM), depth processing (e.g., Kirchhoff prestack depth migration (KPSDM), tomography (Tomo)), time processing (e.g., Kirchhoff prestack time migration (KPSTM), general surface multiple prediction (GSMP), extended interbed multiple prediction (XIMP)), framework foundation features, desktop features (e.g., GUIs, etc.), and development tools.

As an example, the computational framework 1500 can include one or more features for visualization of data of one or more datasets. For example, the computational framework 1500 can include features to perform a method such as, for example, the method 600 of FIG. 6.

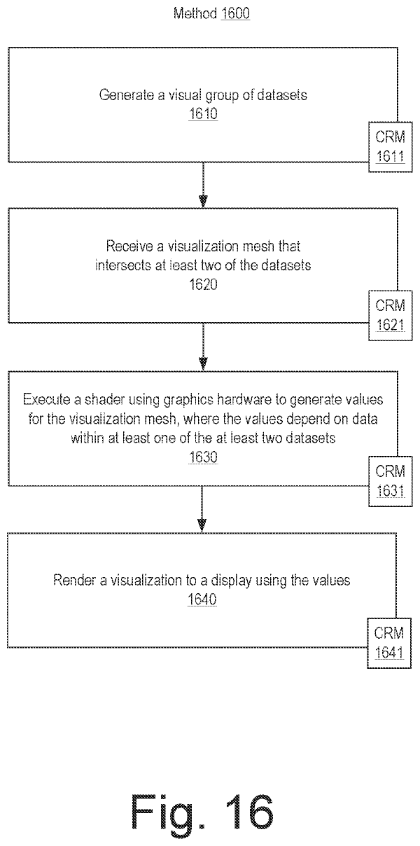

FIG. 16 shows an example of a method 1600 that can include a generation block 1610 for generating a visual group of datasets; a reception block 1620 for receiving a visualization mesh that intersects at least two of the datasets; an execution block 1630 for executing a shader using graphics hardware to generate values for the visualization mesh, where the values depend on data within at least one of the at least two datasets; and a render block 1640 for rendering a visualization to a display using the values.

The method 1600 is shown in FIG. 16 in association with various computer-readable media (CRM) blocks 1611, 1621, 1631 and 1641. Such blocks generally include instructions suitable for execution by one or more processors (or cores) to instruct a computing device or system to perform one or more actions. While various blocks are shown, a single medium may be configured with instructions to allow for, at least in part, performance of various actions of the method 1600. As an example, a CRM block can be a computer-readable storage medium that is non-transitory, not a carrier wave and not a signal. As an example, such blocks can include instructions that can be stored in memory and can be executable by one or more of processors.

As an example, a method such as the method 1600 of FIG. 16 may be implemented as part of a framework such as the OMEGA framework, the PETREL framework, etc. As an example, the method 1600 may be implemented using the DELFI environment. The method 1600 of FIG. 16 may include one or more of the blocks of the method 600 of FIG. 6.

As an example, a visualization process can implement one or more of various features that can be suitable for one or more web applications. For example, consider use of the JAVASCRIPT object notation format (JSON) and/or one or more other languages/formats. As an example, a framework may include one or more converters. For example, consider a JSON to PYTHON converter and/or a PYTHON to JSON converter.

As an example, a system may utilize one or more types of application programming interfaces (APIs). For example, a request an application sends to a cloud storage JSON application programming interface (API) can be processed for authorization to identify the application to the cloud platform, which may occur in using an OAuth 2.0 token (which also authorizes the request) and/or using the application's API key.

As an example, if a request demands authorization (such as a request for private data), then the application is to provide an OAuth 2.0 token with the request; noting that the application may also provide the API key. As an example, if a request does not demand authorization (e.g., a request for public data), then no identification is demanded; however, the application may still provide the API key, an OAuth 2.0 token, or both. An application in the GOOGLE CLOUD platform can use OAuth 2.0 to authorize requests.

OAuth 2.0 provides for tokens and token management. For example, consider token introspection (see, e.g., RFC 7662), to determine the active state and meta-information of a token, token revocation (see, e.g., RFC 7009), to signal that a previously obtained token is no longer needed, and JAVASCRIPT object notation (JSON) Web Token (JWT) (see, e.g., RFC 7519).

As an example, system may include one or more types of APIs for accessing data, processing data, rendering data, determining a loading order, etc. As an example, an API may be a Representational State Transfer (REST) API, which may be of a style that defines a set of constraints to be used for creating services. Services that conform to the REST architectural style, termed RESTful web services, provide interoperability between computer systems on the Internet, a cloud platform, etc. RESTful web services can allow one or more requesting systems to access and manipulate textual representations of web resources by using a uniform and predefined set of stateless operations. As an example, one or more other kinds of web services may be utilized (e.g., such as SOAP web services) that may expose their own sets of operations.

As an example, an HTTP-based RESTful API may be defined with the following aspects: a base URI, such as http://api.example.com/; a standard HTTP methods (e.g., GET, POST, PUT, and DELETE); a media type that defines state transition data elements (e.g., Atom, microformats, application/vnd.collection+json, etc.). A current representation can tell a client how to compose requests for transitions to next available application states, which may be via a URI, a JAVA applet, etc.

RESTful implementations can make use of one or more standards, such as, for example, HTTP, URI, JSON, and XML. As an example, an API may be referred to as being RESTful, though it may not fulfil each architectural constraint (e.g., uniform interface constraint, etc.).

As an example, one or more features of the computational framework 1200 may be accessed using an API or APIs. As an example, a workflow can include accessing another workflow, where such workflows may utilize different computational frameworks. As an example, a method may act to assure that data that may be or include proprietary and/or otherwise restricted data (e.g., seismic data, etc.) is properly handled with authority. As an example, where a seismic volume includes different types of security measures that may restrict resolution, spatial regions, access, access rate, such types may be taken into consideration when determining loading (e.g., a loading order, etc.) and/or rendering.

As an example, a system may be at least in part cloud-based. For example, a cloud platform may include compute tools, management tools, networking tools, storage and database tools, large data tools, identity and security tools, and machine learning tools. As an example, a cloud platform can include identity and security tools that can provide a key management service (KMS) tool. Key management can provide for management of cryptographic keys in a cryptosystem, which can include task associated with the generation, exchange, storage, use, crypto-shredding (destruction) and replacement of keys. It can include cryptographic protocol design, key servers, user procedures, and other relevant protocols. As an example, a system may include features of one or more cloud platforms (e.g., GOOGLE CLOUD, AMAZON WEB SERVICES CLOUD, AZURE CLOUD, etc.). As an example, the DELFI cognitive exploration and production (E&P) environment may be implemented at least in part in a cloud platform.

As an example, a cloud platform may provide for object storage, block storage, file storage (e.g., a shared filesystem), managed SQL databases, NoSQL databases, etc. As to types of data, consider one or more of text, images, pictures, videos, audio, objects, blobs, structured data, unstructured data, low latency data, high-throughput data, time series data, semi-structured application data, hierarchical data, durable key-value data, etc. For example, particular data may be utilized in visual renderings and demand low latency such that glitches do not occur during buffering, rendering, interactive manipulations, etc. As an example, particular data may be generated as a binary large object (blob) for purposes of transmission, security, storage organization, etc. As an example, a sensor (e.g., a seismic sensor, which may be a seismic receiver, etc.) may generate time series data, which may be regular and/or irregular in time and which may or may not include a “global” time marker (e.g., time stamps, etc.). As an example, data may be in a wellsite information transfer standard markup language (WITSML) standard, which is a standard utilized in various operations including rig operations. As an example, data may be serially transferred ASCII data.

As an example, one or more machine learning tools may be utilized for training a machine learning model and/or using a machine learning (ML) model. As an example, a trained ML model (e.g., a trained ML tool that includes hardware, etc.) can be utilized for one or more tasks. As an example, various types of data may be acquired and optionally stored, which may provide for training one or more ML models, for retraining one or more ML models, for further training of one or more ML models, and/or for offline analysis, etc.

As an example, an earth model such as a multidimensional model of a volume where at least some seismic data have been acquired may be utilized in a method that involves loading of seismic data. In such an example, the earth model may be utilized in combination with a ML model, for example, to help determine one or more loading parameters, processing parameters, rendering parameters, etc.

As an example, the TENSORFLOW framework (Google LLC, Mountain View, CA) may be implemented, which is an open source software library for dataflow programming that includes a symbolic math library, which can be implemented for machine learning applications that can include neural networks. As an example, the CAFFE framework may be implemented, which is a DL framework developed by Berkeley AI Research (BAIR) (University of California, Berkeley, California). As another example, consider the SCIKIT platform (e.g., scikit-learn), which utilizes the PYTHON programming language. As an example, a framework such as the APOLLO AI framework may be utilized (APOLLO.AI GmbH, Germany). As an example, a framework such as the PYTORCH framework may be utilized (Facebook AI Research Lab (FAIR), Facebook, Inc., Menlo Park, California). As an example, a loading process may utilize one or more machine learning model-based techniques. As an example, an image recognition approach may be utilized in determining a loading order for loading a seismic volume where, for example, features, regions, etc., can be associated with corresponding data rates, data amounts, data times, etc., which may facilitate one or more types of workflows that can enhance user experience (e.g., reduce time, reduce eyestrain, etc.).

As an example, one or more ML models may be utilized to determine scaling of a multi-scale resolution process for rendering a visualization. As an example, one or more ML models may be utilized for tracking one or more features, planning a seismic survey, assessing seismic data quality, facilitating model building, etc. As an example, one or more ML models may be utilized to determine size, shape and orientation of a visualization surface (e.g., a visualization mesh) that may intersect multiple datasets. As an example, features in a region may be utilized as milestones for purposes of construction of a visualization mesh. As an example, a method may include utilization of one or more implicit functions for visualizations. For example, consider a stratigraphic function that may be a type of implicit function that represents stratigraphy in a subsurface region. In such an example, horizons may correspond to various implicit function values (e.g., stratigraphic attribute values).

As an example, a method can include generating a visual group of datasets; receiving a visualization mesh that intersects at least two of the datasets; executing a shader using graphics hardware to generate values for the visualization mesh, where the values depend on data within at least one of the at least two datasets; and rendering a visualization to a display using the values. In such an example, the datasets can include one or more seismic datasets, where, for example, seismic data (e.g., seismic datasets) may include different inlines and xlines (e.g., different acquisition geometries).

As explained, data can be volumetric and considerable in size such that memory and processing operations can be challenging. As explained, a method may include performing multi-scale resolution rendering where, for example, multiple scales can depend on one or more factors, which may include data quality, data coverage within a dataset and/or a domain (e.g., a basin), proximity to a well or wells, etc. For example, a method can include identifying one or more wells and/or other features and providing for multi-scale rendering where resolution is finer at and/or proximate to the one or more wells and/or other features.

As an example, datasets may correspond to a common geologic region. As an example, two or more datasets may overlap in space and/or two or more datasets may not overlap in space.

As an example, rendering can include multi-scale rendering, which may rely on one or more techniques such as, for example, one or more tree techniques. As explained, finer and coarser resolutions may be determined using one or more factors (e.g., camera, features, size, shape, etc.). As an example, where two datasets are at some considerable distance apart with a large gap (e.g., tens of kilometers or more), resolution may be finer for the datasets than for a gap region, which may or may not have data coverage.

As an example, datasets can be organized or otherwise accessed using a tree format, where, for example, the tree format defines bricks. In such an example, the tree format may be an octree format.

As an example, a method can include receiving a camera orientation where rendering renders a visualization to the display using the camera orientation. As an example, a camera may provide for zooming, panning, scene capture, etc.

As an example, a visualization mesh can include a plane or planes. As an example, a visualization mesh can include a surface that includes a curve or curves. As an example, a visualization mesh may be generated using an extrusion technique. For example, in FIG. 11, a user may move a cursor via a mouse, a trackball, a stylus, etc., where a line is generated and where a framework can then extrude the line in one or more directions to form a sheet. In such an example, a framework may provide for control of directions, for example, to be up and/or down and/or to be at an angle, curved, etc. As explained, a framework can provide for rapid visualization of data and/or attributes thereof within multiple datasets, which may be within a common domain such as, for example, a basin.

A basin can be a sedimentary basin that is a depression in the crust of the Earth formed by plate tectonic activity in which sediments accumulate. Continued deposition can cause further depression or subsidence. Sedimentary basins, or simply basins, can vary, for example, from bowl-shaped to elongated troughs. If rich hydrocarbon source rocks occur in combination with appropriate depth and duration of burial, hydrocarbon generation can occur within a basin. As explained, a basin can be of a particular shape where, at times, one or more factors may present issues as to seismic imaging. For example, land rights, weather, water, sand, elevations, etc., can present issues when conducting a seismic survey. Thus, in some instances, one or more gaps may exist in datasets from a single seismic survey and/or from multiple seismic surveys. As explained, a framework can handle visualizations for such instances where a user can readily visualize subsurface features across multiple datasets even though one or more of the multiple datasets may not be adjacent to another one of the multiple datasets.

As an example, a method can include highlighting at least a portion of a visualization to indicate a subsurface structure and/or highlighting at least a portion of the visualization to indicate data quality. As explained, a method can facilitate interpretation of subsurface structures and/or can facility data assessments such as assessment of data quality. As to data quality, where an undesirable gap exists, a new seismic survey may be planned where geometry of the seismic survey can be discerned from a visualization. For example, consider a method that can provide for planning of a seismic survey in an optimal manner that fills in a gap, which may be a gap in coverage, a gap in data quality, etc. As an example, such a method may include generating synthetic seismic data for one or more regions where the synthetic seismic data can be rendered along with actual, field acquired seismic data.

As an example, a method may provide for visualizing one or more model building processes that may include comparing synthetic seismic data to actual, field acquired seismic data. In such an example, synthetic seismic data may be provided as volumetric data within a region where some overlap exists with one or more datasets of actual, field acquired seismic data. As an example, a framework can provide for highlighting differences between synthetic and actual seismic data, which may facilitate model building such that a more accurate model may be built with lesser error between synthetic and actual seismic data.

As an example, datasets can include datasets for different times. For example, consider 4D seismic data. 4D seismic data can include 3D seismic data acquired at different times over a common region, for example, to assess changes in a producing hydrocarbon reservoir with time. For example, changes may be observed in fluid location and saturation, pressure and temperature. 4D seismic data are one of several forms of time-lapse seismic data; noting that data may be acquired on a surface, in a borehole, etc. Acquisition may be onshore or offshore and utilize strings of sensors such as streamers and/or discrete sensors (e.g., ocean bottom nodes, etc.).

As an example, a method can include rendering values of a visualization with respect to different times. As an example, a method can include rendering an animation with respect to time and/or with respect to space.

As an example, a method can include performing tracking on values of a visualization. In such an example, tracking can include jumping over one or more gaps, handling one or more overlaps, etc. As an example, as to jumping over a gap, consider the example of FIG. 11 where a tracked feature in one of the datasets may have directionality such that a jump can follow that directionality. As an example, tracking may be performed in individual datasets and, as appropriate, gaps filled in once the individual datasets have been tracked. For example, tracked features in a number of datasets can provide for directionality as to where those features may be in one or more other datasets. In such an example, an optimization may be performed that optimizes an overall tracking process for tracking one or more features in multiple datasets. In such an example, tracking in one dataset may help to inform or adjust tracking in another dataset. As explained, tracking may be utilized to track a subsurface structure in a visualization across multiple datasets.

As an example, a system can include a processor; memory operatively coupled to the processor; a network interface; and processor-executable instructions stored in the memory to instruct the system to: generate a visual group of datasets; receive a visualization mesh that intersects at least two of the datasets; execute a shader using graphics hardware to generate values for the visualization mesh, where the values depend on data within at least one of the at least two datasets; and render a visualization to a display using the values.

As an example, one or more computer-readable storage media can include processor-executable instructions to instruct a computing system to: generate a visual group of datasets; receive a visualization mesh that intersects at least two of the datasets; execute a shader using graphics hardware to generate values for the visualization mesh, where the values depend on data within at least one of the at least two datasets; and render a visualization to a display using the values.

As an example, a computer program product can include computer-executable instructions to instruct a computing system to perform one or more methods such as, for example, one or more of the methods of FIG. 6, FIG. 16, etc.

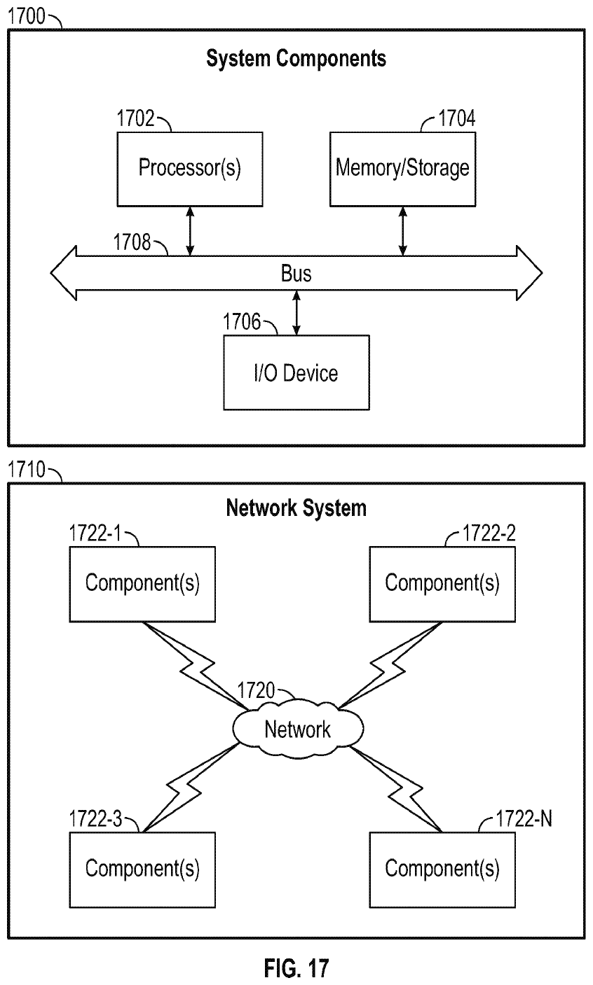

FIG. 17 shows components of an example of a computing system 1700 and an example of a networked system 1710 that includes a network 1720, which may be utilized to perform a method, to form a specialized system, etc. The system 1700 includes one or more processors 1702, memory and/or storage components 1704, one or more input and/or output devices 1706 and a bus 1708. In an example embodiment, instructions may be stored in one or more computer-readable media (e.g., memory/storage components 1704). Such instructions may be read by one or more processors (e.g., the processor(s) 1702) via a communication bus (e.g., the bus 1708), which may be wired or wireless. The one or more processors may execute such instructions to implement (wholly or in part) one or more attributes (e.g., as part of a method). A user may view output from and interact with a process via an I/O device (e.g., the device 1706). In an example embodiment, a computer-readable medium may be a storage component such as a physical memory storage device, for example, a chip, a chip on a package, a memory card, etc. (e.g., a computer-readable storage medium).

In an example embodiment, components may be distributed, such as in the network system 1710 that includes a network 1720. The network system 1710 includes components 1722-1, 1722-2, 1722-3, . . . 1722-N. For example, the components 1722-1 may include the processor(s) 1702 while the component(s) 1722-3 may include memory accessible by the processor(s) 1702. Further, the component(s) 1702-2 may include an I/O device for display and optionally interaction with a method. The network may be or include the Internet, an intranet, a cellular network, a satellite network, etc.

As an example, a device may be a mobile device that includes one or more network interfaces for communication of information. For example, a mobile device may include a wireless network interface (e.g., operable via IEEE 802.11, ETSI GSM, BLUETOOTH, satellite, etc.). As an example, a mobile device may include components such as a main processor, memory, a display, display graphics circuitry (e.g., optionally including touch and gesture circuitry), a SIM slot, audio/video circuitry, motion processing circuitry (e.g., accelerometer, gyroscope), wireless LAN circuitry, smart card circuitry, transmitter circuitry, GPS circuitry, and a battery. As an example, a mobile device may be configured as a cell phone, a tablet, etc. As an example, a method may be implemented (e.g., wholly or in part) using a mobile device. As an example, a system may include one or more mobile devices.

As an example, a system may be a distributed environment, for example, a so-called “cloud” environment where various devices, components, etc. interact for purposes of data storage, communications, computing, etc. As an example, a device or a system may include one or more components for communication of information via one or more of the Internet (e.g., where communication occurs via one or more Internet protocols), a cellular network, a satellite network, etc. As an example, a method may be implemented in a distributed environment (e.g., wholly or in part as a cloud-based service).

As an example, information may be input from a display (e.g., consider a touchscreen), output to a display or both. As an example, information may be output to a projector, a laser device, a printer, etc. such that the information may be viewed. As an example, information may be output stereographically or holographically. As to a printer, consider a 2D or a 3D printer. As an example, a 3D printer may include one or more substances that can be output to construct a 3D object. For example, data may be provided to a 3D printer to construct a 3D representation of a subterranean formation. As an example, layers may be constructed in 3D (e.g., horizons, etc.), geobodies constructed in 3D, etc. As an example, holes, fractures, etc., may be constructed in 3D (e.g., as positive structures, as negative structures, etc.).

Although only a few example embodiments have been described in detail above, those skilled in the art will readily appreciate that many modifications are possible in the example embodiments. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures.

What is claimed is:

1. A method comprising:
generating a visual group of datasets;
receiving a visualization mesh that intersects at least two of the datasets;
executing a shader using graphics hardware to generate values for the visualization mesh, the values depend on data within at least one of the at least two datasets; and
rendering a visualization to a display using the values.

2. The method of claim 1, wherein the datasets include seismic datasets.

3. The method of claim 2, wherein the seismic datasets include different inlines and xlines.

4. The method of claim 1, wherein the datasets correspond to a common geologic region.

5. The method of claim 1, wherein two or more of the datasets overlap in space.

6. The method of claim 1, wherein two or more of the datasets do not overlap in space.

7. The method of claim 1, wherein the rendering includes multi-scale rendering.

8. The method of claim 1, wherein the datasets include a tree format and the tree format defines bricks.

9. The method of claim 8, wherein the tree format includes an octree format.

10. The method of claim 1, comprising receiving a camera orientation, the rendering renders the visualization to the display using the camera orientation.

11. The method of claim 1, wherein the visualization mesh includes a plane.

12. The method of claim 1, wherein the visualization mesh includes a surface that includes a curve.

13. The method of claim 1, comprising highlighting at least a portion of the visualization to indicate a subsurface structure.

14. The method of claim 1, comprising highlighting at least a portion of the visualization to indicate data quality.

15. The method of claim 1, wherein the datasets include datasets for different times.

16. The method of claim 15, wherein the values of the visualization are renderable with respect to the different times.

17. The method of claim 1, comprising performing tracking on the values of the visualization.

18. The method of claim 17, wherein the tracking tracks a subsurface structure in the visualization across multiple datasets.

19. A system comprising:
a processor;
memory operatively coupled to the processor;
a network interface; and
processor-executable instructions stored in the memory to instruct the system to:
generate a visual group of datasets;
receive a visualization mesh that intersects at least two of the datasets;
execute a shader using graphics hardware to generate values for the visualization mesh, the values depend on data within at least one of the at least two datasets; and
render a visualization to a display using the values.

20. One or more computer-readable storage media comprising processor-executable instructions to instruct a computing system to:
generate a visual group of datasets;
receive a visualization mesh that intersects at least two of the datasets;
execute a shader using graphics hardware to generate values for the visualization mesh, the values depend on data within at least one of the at least two datasets; and
render a visualization to a display using the values.
